(19) United States
(12) Patent Application Publication
(10) Pub. No.: US 2010/0232768 A1
(43) Pub. Date: Sep. 16, 2010

(54) RECORDING DEVICE, REPRODUCING DEVICE, AND METHOD

(76) Inventors: Tsuyoshi Nakamura, Fukuoka (JP); Tadanori Tezuka, Fukuoka (JP)

Correspondence Address: WENDEROTH, LIND & PONACK L.L.P., 1030 15th Street, N.W., Suite 400 East, Washington, DC, 20005-1503, US

(21) Appl. No.: 12/740,410

(22) PCT Filed: Mar. 3, 2009
(86) PCT No.: PCT/JP2009/000962

§ 371 Date: Apr. 29, 2010

(30) Foreign Application Priority Data
Mar. 3, 2008 (JP) 2008-051773

(51) Int. Cl. H04N 7/26

(52) U.S. Cl. 386/109; 386/E05.007

(57) ABSTRACT

A video encoder (900) includes a second coding unit (510) and a second adding unit (512) to obtain a high image quality with a small processing amount. The second coding unit (510) codes one frame (frame 1+2) out of two consecutive frames (frame (1+2), frame (3+4)) included in a stream (for example, k-th record-calculation-input stream in a second group shown in FIG. 5). The second adding unit (512) adds the one frame to the other frame (frame (3+4)). The stream is coded by coding the one frame and the added frame.

### TECHNICAL FIELD

The present invention relates to a method of recording and reproducing a moving picture in high speed imaging, and a device of the same.

### BACKGROUND ART

MPEG is one of compression coding techniques used for moving pictures. As main MPEG specifications which have recently come into widespread use, there are MPEG 2, MPEG 4, MPEG 4AVC, and so on. The main characteristic of the compression technique is to perform variable length coding after performing DCT (discrete cosine transform) and quantization on a difference between an image frame to be coded (hereinafter referred to as a current frame and an image frame that has been coded and reconstructed (hereinafter referred to as a reference frame).

FIG. 1 is a diagram which shows a conventional technique.

In the case where two frames are coded during a period T by a coding device according to MPEG as shown in FIG. 1(a), for example, the relationship between current frames shown with frame numbers 1 to 4 and reference frames each of which is for corresponding one of the current frames is in a reference relationship (there are reference relationships between 1 and 2, 2 and 3, and 3 and 4).

FIG. 2 is a diagram which shows an example of consecutive display and decimation display.

In the case where data coded under the above-described condition is reproduced by a decoding device according to MPEG, first, reproduction is performed while decoding frames in order starting from a frame 1 when performing consecutive reproducing at an interval of period T, as shown in FIG. 2 (a). On the other hand, in the case where the frames 1 and 3 are reproduced using a decimation technique at an interval of period T as shown in FIG. 2(b), the frame 2 also needs to be decoded in order to reproduce the frame 3 due to the reference relationship between the frame 3 and the 2. That means even a frame that does not have to be reproduced needs to be decoded when the frame is in a reference relationship. For the above reason, a large processing amount is required for decoding and there has been a problem that decimation reproduction is difficult for a device that is capable of decoding, in the period T, only one frame of coded data in which the reference relationship exists in plural frames included in the period T.

To address the above problem, coding is performed in a reference relationship as shown by arrows of FIG. 1(b) in Patent Reference 1 (the reference relationship exists between 1 and 2, 1 and 3, and 3 and 4). This enables a decoding device to skip decoding of the frame 2 in the case where the frames 1 and 3 are reproduced using a decimation technique.

FIG. 3 is a diagram which shows a conventional technique.

Applying the technique of Patent Reference 1 to coding of a moving picture frame in high speed imaging makes it possible to provide a reproducing device in which a processing load is prevented from increasing when performing: slow reproduction at ¼ speed as shown in FIG. 3(b); slow reproduction at ½ speed as shown in FIG. 3(c); and slow reproduction t 1/1 speed as shown in FIG. 3(d) (constant speed) in the case where 4 times the normal number of frames are inputted during the period T as shown in FIG. 3(a).

However, decimation reproduction on a moving picture captured in high speed imaging lacks appropriate motion blur for a reproduction speed, and thus there are problems that a moving picture becomes more unnatural as the reproduction speed becomes closer to a constant reproduction speed, and that image quality is low due to a relatively short exposure time compared to a normal imaging.

FIG. 4 is a diagram which shows a conventional technique.

In order to solve the problems described above, according to Patent Reference 2, reproduction is carried out while adding frames in ¼, ½, and 1/1 (constant speed), as shown in FIGS. 4(b) to 4(d) in the case where 4 times the normal number of frames are inputted during the period T as shown in FIG. 4(a).

However, in the case where reproduction is performed while adding frames, all of the frames need to be decoded even when using the decimation technique, and thus load on the reproducing device increases as the reproduction speed becomes closer to a constant reproduction speed.

Patent Reference 1: Japanese Unexamined Patent Application Publication No. 2003-299103

Patent Reference 2: Japanese Unexamined Patent Application Publication No. 2006-33242

### DISCLOSURE OF INVENTION

### Problems that Invention is to Solve

With conventional techniques, it has been difficult to simultaneously improve an image quality and processing load. The present invention presents a recording and reproducing method and a device of the same which allow both obtaining an excellent image quality and preventing increase in processing load of a moving picture in high speed imaging.

More specifically, according to the technique shown in FIG. 3, whereas the processing amount can be reduced with the technique of skipping shown in FIG. 1(b), the image quality is low. On the other hand, according to the technique shown in FIG. 4, whereas a high image quality is obtained, skipping cannot be carried out in order to obtain an added frame, and thus the processing amount cannot be reduced using the technique shown in FIG. 1(b) and the processing amount becomes large.

The present invention has been conceived in view of the above problems, and aims to obtain a high image quality with a smaller processing amount, even when decimation reproduction is performed, with which display content that is shown by reproducing two frames in normal reproduction can be shown by reproducing only one frame, in addition to the case where the normal reproduction which reproduces both two frames is performed.

### Means to Solve the Problems

A recording device according to an implementation of the present invention is a recording device that includes: a coding unit configured to code one frame out of two consecutive frames included in a stream; and an adding unit configured to add an other frame of the two frames and the one frame. Further, a reproducing device according to an implementation of the present invention is a reproducing device that includes: a decoding unit configured to decode a coded frame obtained by coding one frame, into the one frame, and a subtracting unit configured to subtract the one frame from an added frame in which the one frame and the other frame that follows the one frame are added so as to generate a subtracted frame as the other frame.

With this, in the case where display content which can be viewed by reproducing both two frames is presented to be viewed by reproducing only one frame (in the case where decimation reproduction is carried out), it is possible to reproduce an added frame and to prevent a lack of motion blur, for example, thereby obtaining high image quality.

In addition, when the added frame is reproduced, decoding is simply performed on the added frame. Since the number of frames to be decoded is one, it is sufficient to decode a small number of frames. This allows a small amount of processing amount to be sufficient. Further, when both of two frames are reproduced, two frames composed of one frame and the other frames are decoded, and the number of frames to be decoded is maintained to be small. Here, the processing amount of subtracting a frame is relatively small when compared to the processing amount of decoding a frame. On the other hand, the added frame is coded at the time of coding, in addition to simply coding one frame, and thus the number of frames to be coded is maintained to be small. It is to be noted here that, the processing amount of adding a frame is small as well.

Thus, a high image quality can be obtained with a smaller processing amount in both cases of normal reproduction and a decimation reproduction.

### EFFECTS OF THE INVENTION

According to the present invention, it is possible to provide a recording and reproducing method and a device of the same which allow both obtaining an excellent image quality and preventing increase in processing load of a moving picture in high speed imaging

### BRIEF DESCRIPTION OF DRAWINGS

FIG. 1 is a diagram which shows a conventional technique.

FIG. 2 is a diagram which shows an example of consecutive reproduction with (a) and an example of decimation reproduction with (b).

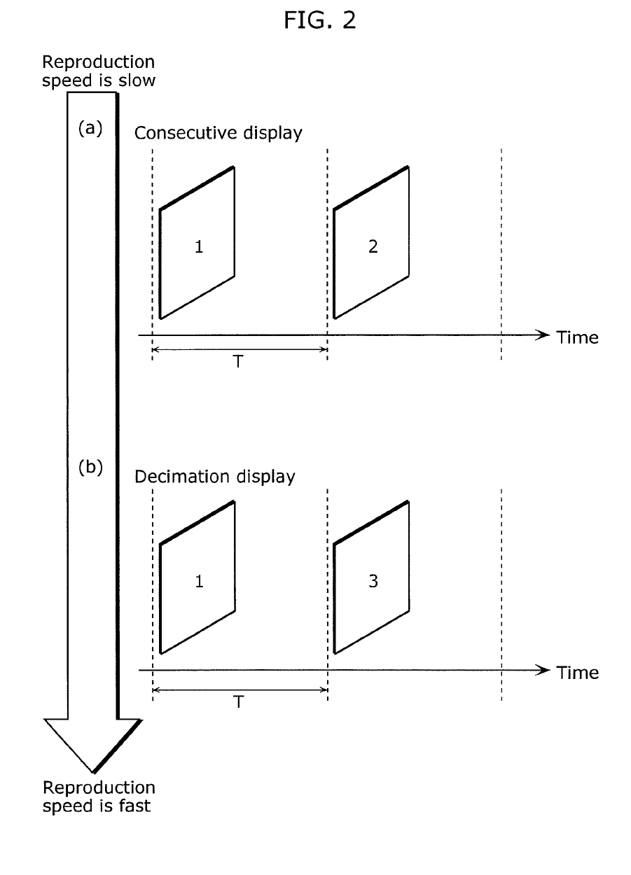

FIG. 3 is a diagram which shows a conventional technique.

FIG. 4 is a diagram which shows a conventional technique.

FIG. 5 is a diagram which shows a recording system according to a first embodiment of the present invention.

FIG. 6 is a diagram which shows a reproducing system according to a second embodiment of the present invention.

FIG. 7 is a configuration diagram of a recording device according to the first embodiment of the present invention.

FIG. 8 is a configuration diagram of a reproducing device according to the first embodiment of the present invention.

FIG. 9 is a configuration diagram of a video camera system.

FIG. 10 is a configuration diagram of a digital television system.

FIG. 11 is a diagram which shows a computing amount in a recording processing compared between a conventional technique and the present embodiment.

FIG. 12 is a diagram which shows a computing amount in a reproducing processing compared between a conventional technique and the present embodiment.

FIG. 13 is a flow chart of a processing using a program.

FIG. 14 is a flow chart of a processing by a reproducing unit.

FIG. 15 is a diagram which shows a configuration of a video encoder.

FIG. 16 is a diagram which shows a multiplex stream.

FIG. 17 is a diagram which shows a configuration of a video decoder.

FIG. 18 is a diagram which shows a multiplex stream which is input into the video decoder.

FIG. 19 is a diagram which shows a configuration of a header of a program.

FIG. 20 is a diagram which shows a configuration of an encoding processing portion that is caused to start processing by an encoding calling portion.

FIG. 21 is a diagram which shows a configuration of a decoding processing portion that is called by a decoding processing calling portion.

FIG. 22 is a diagram which shows a configuration of a recording processing portion that is caused to start executing by a recording processing calling portion.

FIG. 23 is a diagram which shows a configuration of a reproducing processing portion that is called by a reproducing processing calling portion of a main portion.

FIG. 24 is a diagram which shows a configuration of a main portion of a program.

FIG. 25 is a diagram which shows an operation of a video camera system.

### NUMERICAL REFERENCES

500 input unit
501 first selecting unit
504 first coding unit
506 first adding unit
507 second selecting unit
510 second coding unit
512 second adding unit
514 third coding unit
516 second recording and calculating unit

### BEST MODE FOR CARRYING OUT THE INVENTION

Embodiments according to the present invention will be described below with reference to the drawings.

In order to solve conventional problems, in the recording method according to the present invention, Log 2N+1 bitstream is generated by repeating Log 2N times (base 2 logarithm) the following processes for N frames (N is a power of two): recording a bitstream in which an odd-numbered frame is coded; generating a frame in which the odd-numbered frame and an even-numbered frame are added together, and recording a bitstream in which coding is performed on only the odd-numbered frame of the added frame.

On the other hand, in a reproducing method according to the present invention, the following processes are carried out, for N frames (N is a power of two), on a first bitstream in which an odd-numbered frame is coded and a bitstream from the second to the (Log 2N+1)th bitstream which is obtained by repeating Log 2N times (base 2 logarithm), generating a frame in which an odd-numbered frame and an even-numbered frame of a current frame are added together and recording a bitstream in which coding is performed on only the odd-numbered frame of the added frame: reproducing a frame which is obtained by decoding and reconstructing the (Log 2N+1)th bitstream when reproducing one frame in the N frames; reproducing, as an odd-numbered frame, a frame obtained by decoding and reconstructing the Log 2N-th bitstream and reconstructing and reproducing, as an even-numbered frame, a frame obtained by subtracting the odd-numbered frame from the frame obtained by reconstructing from the (Log 2N+1)-th bitstream when reproducing two frames in the N frames; and reproducing, as an odd-numbered frame, a frame obtained by reproducing and reconstructing the (Log 2M+1)th bitstream (M is a power of 2 and is three or more and less than N), and reproducing, as an even-numbered frame, a frame obtained by subtracting, from M/2 frame obtained by reconstructing from the Log 2M-th bitstream to the (Log 2N+1)th bitstream, the odd-numbered frame obtained by reconstructing from a corresponding (Log 2M+1)th bitstream when reproducing M frames in the N frames.

The following will describe the details.

### Embodiment 1

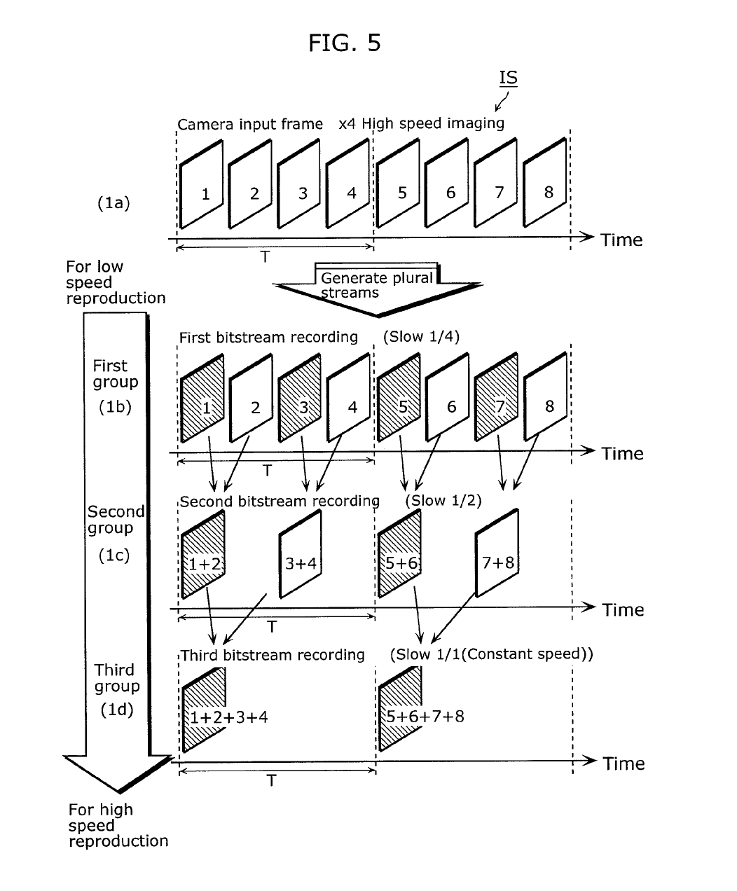

FIG. 5 is a diagram which shows a recording method according to Embodiment 1 of the present invention.

In order to simplify the description below, it is assumed that an input frame in high speed imaging includes four frames in a period T (unit time) as shown in FIG. 5(1a). This means that quad-speed recording is carried out when one frame is recorded in the period T in normal imaging.

First, an outline of the recording method is described with reference to FIG. 5.

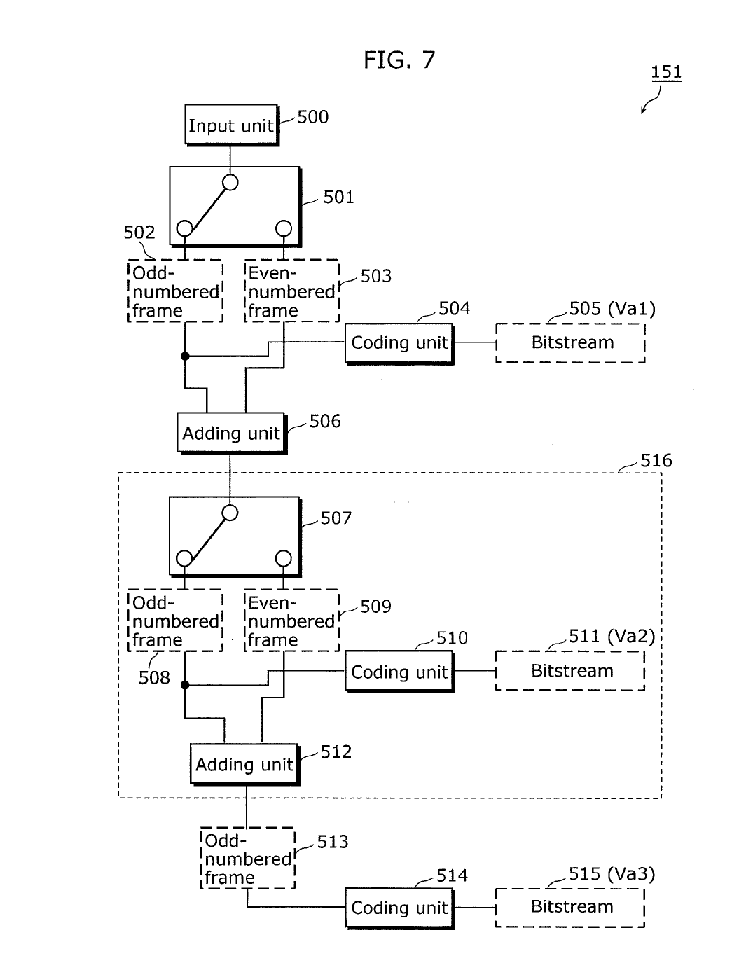

The square of 2 (4=2̂k (k=2, ÂB indicates B-th power of A)) frames 1, 2, 3, and 4 are inputted during the period T as shown in FIG. 5(1a), and a first bitstream obtained by coding the odd-numbered frames 1 and 3 is recorded in the first recording step as shown in FIG. 5(1b) Further, frames 1+2 and 3+4, each of which is obtained by adding one of the odd-numbered frames and one of the even-numbered frames, are generated in the first recording step as shown in FIG. 5(1c). Further, second bitstream obtained by coding the odd-numbered frame of the added frame, that is, the frame 1+2, is recorded in the second recording step (refer to a second recording and calculating unit 516 of FIG. 7 described below). Furthermore, a frame 1+2+3+4 is obtained by adding the odd-numbered frame and the even-numbered frame obtained in the first recording step is generated in the second recording step as shown in FIG. 5(1d). Then the third bitstream obtained by coding the frame 1+2+3+4 is record in the third recording step.

FIG. 7 is a diagram which shows a configuration of a recording unit 151.

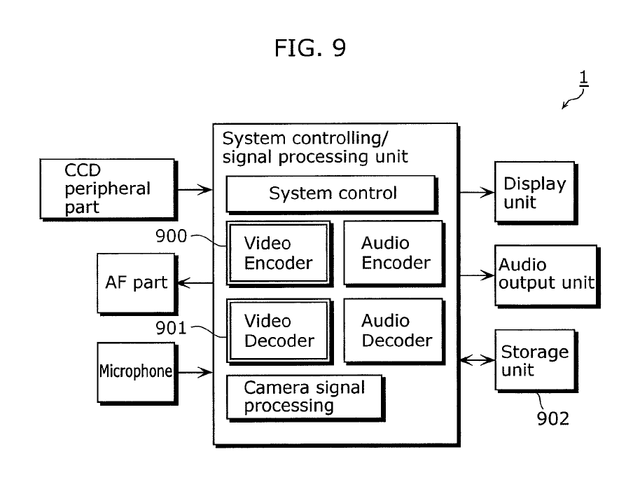

The following describes a recording device (a recording unit 151 and a video encoder 900 of FIG. 9) according to the present Embodiment with reference to FIG. 7.

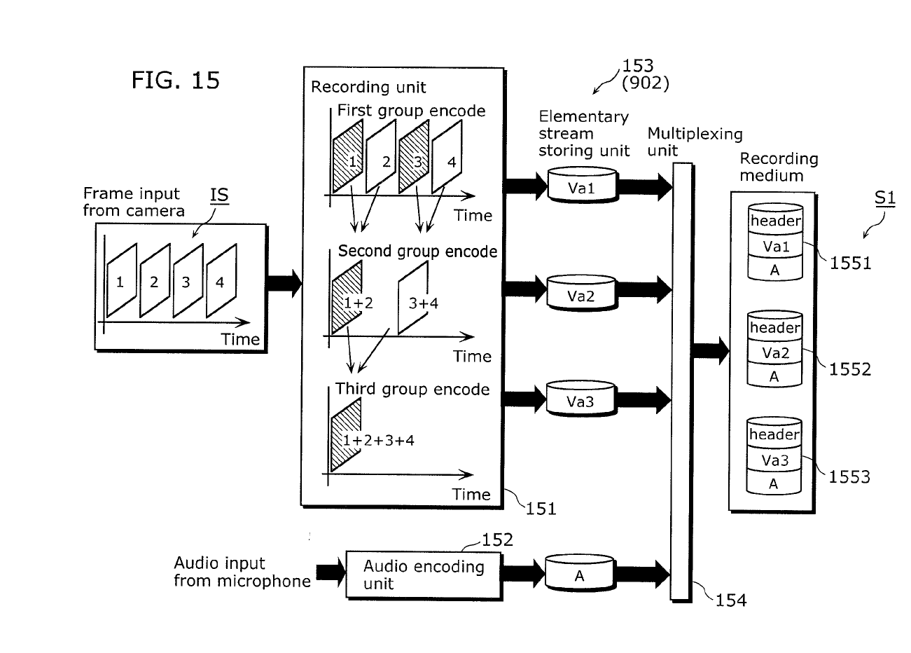

Frames 1, 2, 3, and 4 (refer to FIG. 5, a record and input stream IS (FIG. 5 and FIG. 15), a first record-calculation-input stream) obtained from an input unit 500 are sorted into odd-numbered frames 1 and 3, and even-numbered frames 2 and 4 by a first selecting unit 501 and stored into corresponding storage units 502 and 503, respectively. The odd-numbered frame stored into the storage unit 502 is coded by the first coding unit 504, and a resultant first bitstream (a first record-output stream Va1) is stored into a storage unit 505.

Next, an odd-numbered frame 1+2 and an even-numbered frame 3+4 are generated by a first adding unit 506 from the odd-numbered frame and the even-numbered frame which are stored in the storage units 502 and 503. The added frames 1+2 and 3+4 (a first record-calculation-output stream) are stored into corresponding storage units 508 and 509, respectively, by a second selecting unit 507. The odd-numbered frame stored into the storage unit 508 is coded by the second coding unit 510, and a resultant second bitstream (a second record-output stream Va2) is stored into a storage unit 511.

Lastly, a frame 1+2+3+4 (a second record-calculation-output stream) is generated by a second adding unit 512 from the odd-numbered frame and the even-numbered frame which are stored in the storage units 508 and 509. The added frame 1+2+3+4 is stored into a storage unit 513 (a third record-calculation-input stream). The odd-numbered frame stored into the storage unit 513 is coded by a third coding unit 514, and a resultant third bitstream (a third record-output stream Va3) is stored into a storage unit 515.

It is to be noted that, in the present Embodiment, the number of input frames are explained as 4 (=the square of 2=2̂K) as an example for simplifying the description. However, in the case where N is the power of 2, it is sufficient to include Log 2N (k blocks) processing blocks (the second recording and calculating unit 516). It is also to be noted that, Log 2N+1 (=k+1) recording and calculating units including a third recording and calculating unit in which the coding unit 514 is included may be provided. It is also to be noted that, Log 2N denotes a base 2 logarithm of N.

It is further to be noted that, the coding units 504, 510, and 514 may be shared when performance requirements are satisfied. More specifically, a single large functional block that implements each function of the coding units 504, 510, and 514 may be included. Likewise, the adding units 506 and 512 may also be shared when performance requirements are satisfied.

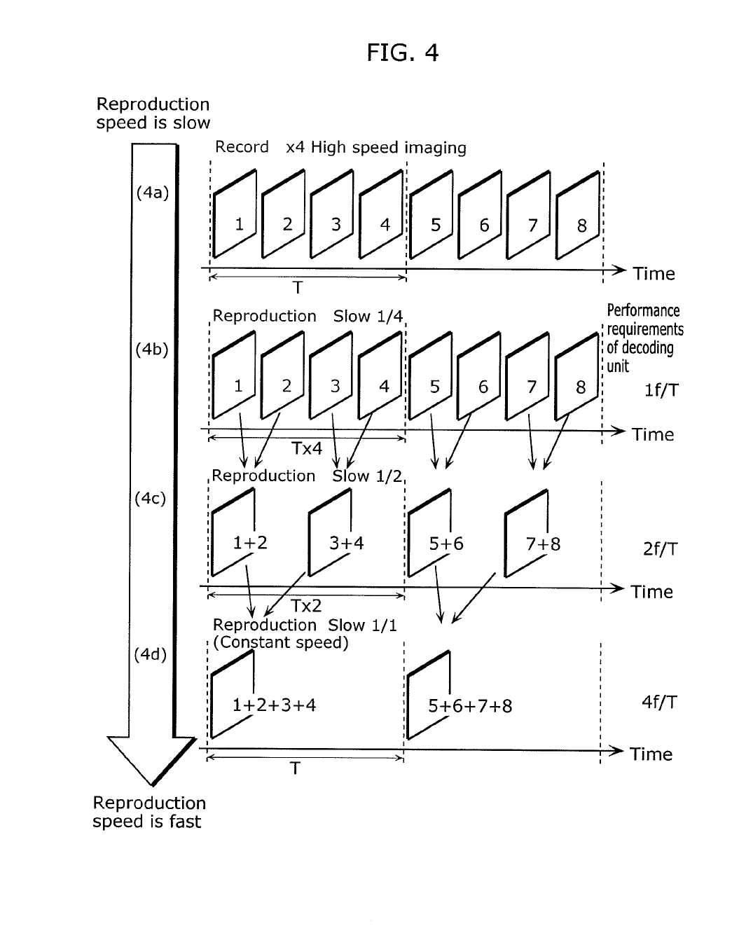

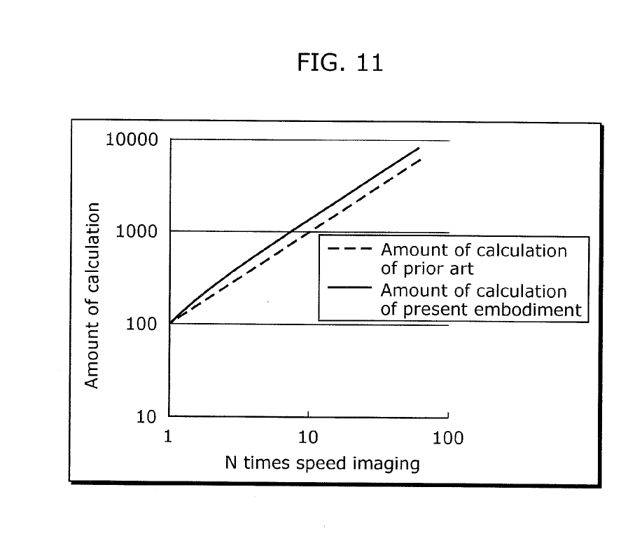

FIG. 11 is a diagram which shows a comparison of computing amount in recording processing, between a prior art (technique shown in FIG. 4) and the present invention.

According to this configuration, when comparing computing amounts between the prior art and the Embodiment 1, in the case where it is assumed that the computing amount of the coding units (the first coding unit to the third coding unit) required for coding a single frame is 100, and the computing amount of the adding units (the first coding unit to the second adding unit) required for generating a single added frame is 40, for example, the computing amount of Embodiment 1 is slightly greater than the computing amount of the prior art by the amount of adding processing, as shown in FIG. 11. In the case where k becomes greater (where n of FIG. 11 becomes greater), however, the processing amount of adding processing is smaller than the processing amount of coding processing, and thus the computing amount of Embodiment 1 becomes the same as the computing amount of the prior art. Further, since plural coding units, adding units, and the like can be included according to the present embodiment, it is easy to perform parallel distributed processing, and it is more useful in lowering power consumption than the prior art. Further, since it is easy to perform parallel distributed processing, the parallel distributed processing can be performed at high speed, and thus processing according to Embodiment 1 can be carried out at higher speed than the prior art even when the processing amount is the same.

### Embodiment 2

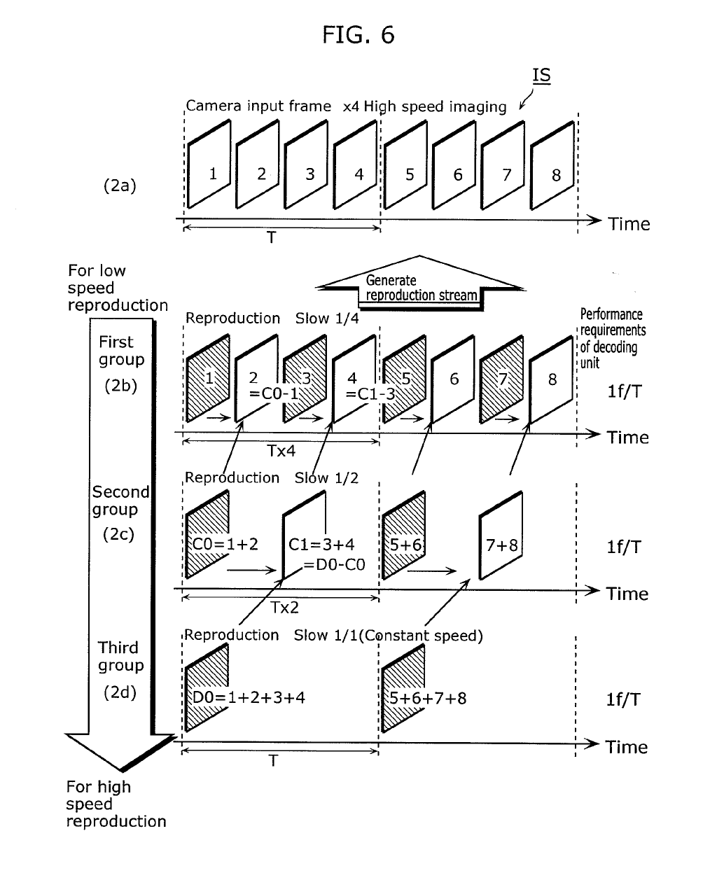

FIG. 6 is a diagram which shows a reproducing method according to Embodiment 2 of the present invention.

In order to simplify the description below, it is assumed that an input frame in high speed imaging includes four frames in a period T as shown in FIG. 6(2a) (record and input stream IS shown in FIG. 5(1a)). This means that quad-speed recording is carried out when one frame is recorded in the period T in normal imaging. First, an outline of the reproducing method is described with reference to FIG. 6.

As shown in FIG. 6(2a), it is assumed that the reproducing method of the present Embodiment is applied to the first to third bitstreams (the first record-output stream Va1 to the third record-output stream Va3 shown in FIG. 7, and first reproduce-input stream Vb3 to the third reproduce-input stream Vb1 generated during the period T from the square of 2 (4=2̂k) frames 1, 2, 3, and 4 using recording system described in Embodiment 1 It is to be noted that, as described below, the first reproduce-input stream Vb 3 to the third reproduce-input stream Vb 1 are also known as the first reproduce-calculate-input stream Vb 3 to the third reproduce-calculate-input stream Vb1.

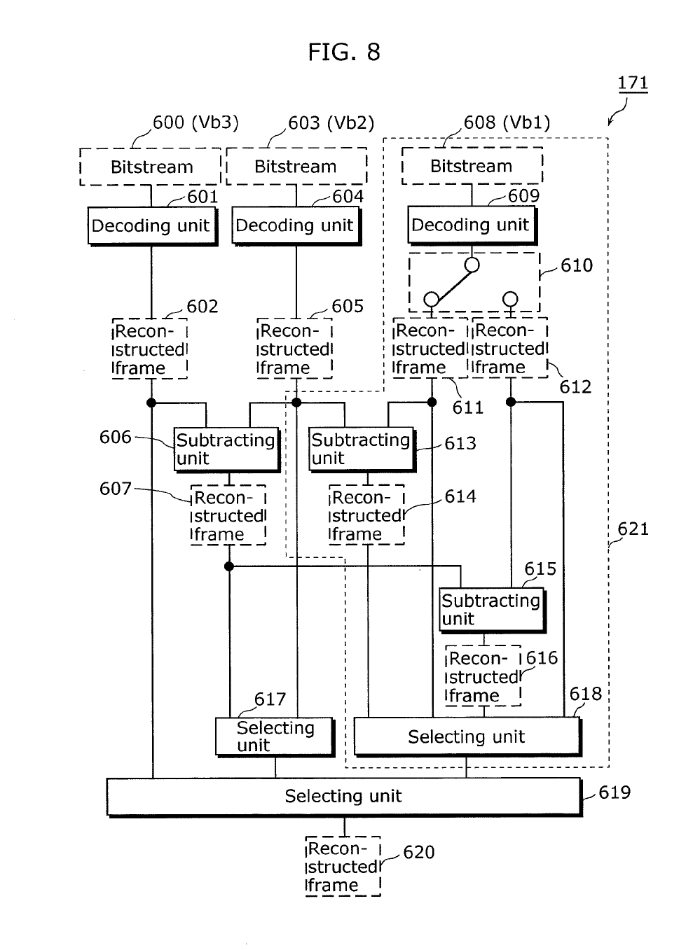

As shown in FIG. 6(2d), when reproducing one frame among four frames, that is, when performing constant speed reproduction (slow reproduction at 1/1 speed, that is, slow reproduction at 1/(2̂ (L−1)) speed (L=1)), a frame D0 (frame 1+2+3+4) obtained by decoding and reconstructing the third bitstream (the third reproduce-input stream Vb3 shown in FIG. 8) is reproduced (the third reproduce-output stream described below). When two frames among four frames are reproduced as shown in FIG. 6(2c), that is, when performing slow reproduction at ½ speed (L=2), a frame obtained by decoding and reconstructing the second bitstream (the second reproduce-input stream Vb2 shown in FIG. 8) is reproduced as an odd-numbered frame C0 (frame 1+2).

Further, when L=2, a frame C1 (frame 3+4) obtained by subtracting the odd-numbered frame C0 (frame 1+2) from the frame D0 (frame 1+2+3+4) reconstructed from the third bitstream (third reproduce-input stream Vb 3 of FIG. 8) is reconstructed and reproduced as an even-numbered frame.

Further, when L=3, that is when reproducing four frames among four frames as shown in FIG. 6(2b), in other words, when performing slow reproduction at ¼ speed, a frame obtained by decoding and reconstructing the first bitstream (the first reproduce-input stream Vb1 of FIG. 8) is reproduced as odd-numbered frames 1 and 3, and a frame 2 obtained by subtracting the odd-numbered frame 1 from the frame C0 reconstructed from the second bitstream (second reproduce-input stream Vb 2 of FIG. 8) and a frame 4 obtained by subtracting the odd-numbered frame 3 from the frame C1 are generated and reproduced as even-numbered frames.

FIG. 8 is a diagram which shows a configuration of a reproducing unit 171.

The following describes a reproducing device (a reproducing unit 171 and a video encoder 901 of FIG. 9) according to the present Embodiment with reference to FIG. 8.

When reproducing one frame among four frames (L=1), that is, when performing constant speed reproduction (slow reproduction at 1/(2̂(L−1)), L=1), the third bitstream (third reproduce-input stream Vb 3, refer to the third group of FIG. 6) stored in a storage unit 600 is reconstructed by a third decoding unit 601 and the reconstructed frame is stored in a recording unit 602. With this, the third record-output stream that is a stream for constant speed reproduction is configured as a stream including the reconstructed frame that is stored.

When reproducing two frames among four frames (when L=2), that is, when performing slow reproduction at ½ speed (1/(2̂(2−1))=1/(2̂(L−1))), the second bitstream stored in a storage unit 603 (the second reproduce-input stream Vb2) is reconstruct by a second decoding unit 604 and the reconstructed frame is stored in a recording unit 605. Then, frames 3+4 are generated from the frame 1+2+3+4 stored in the recording unit 602 and the frame 1+2 stored in the recording unit 605, by a second subtracting unit 606, and the generated frame 3+4 is stored in a recording unit 607. A second selecting unit 617 selects between the frame stored in the recording unit 605 as an odd-numbered frame and the frame stored in the recording unit 607 as an even-numbered frame. With this, the second record-output stream (a stream including a hatched frame and non-hatched frame of FIG. 6(2c)) that is a stream for slow reproduction at ½ speed is configured as a stream configured by each of the frames selected by the second selecting unit 617.

When reproducing four frames out of four frames (when L=3), that is, when performing slow reproduction at ¼ speed, the first bitstream (the first reproduce-input stream Vb1) stored in a storage unit 608 shown at the upper right of FIG. 8 is reconstructed by a first decoding unit 609, and the reconstructed frame is sorted into an odd-numbered frame and an even-numbered frame by a selecting unit 610 (the first portion of the first selecting unit) and stored into a recording unit 611 and 612, respectively. Then, a frame 2 is generated by a subtracting unit 613 (the first portion of the third subtracting unit) from the frame 1+2 stored in the recording unit 605 and the frame 1 stored in the recording unit 611, and the generated frame is stored in a recording unit 614. A frame 4 is generated by a subtracting unit 615 (the second portion of the third subtracting unit) from the frame 3+4 stored in the recording unit 607 and the frame 3 stored in the recording unit 612, and the generated frame 4 is stored in a recording unit 616. A selecting unit 618 (the second portion of the first selecting unit) selects, in order, from: a frame stored in the recording unit 611 as a frame 1; a frame stored in the recording unit 614 as a frame 2; a frame stored in the recording unit 612 as a frame 3; and a frame stored in the recording unit 616 as a frame 4, in this order. With this, the first reproduce-output stream that is a stream for slow reproduction at ¼ speed is configured.

The selecting unit 619 selects a frame according to a reproduction speed and outputs to the storage unit 620 that stores a reproduction frame. It is to be noted that, to be specific, the selecting unit 619 specifies a value of the above-described L from 1 to 3, for example. Then, the above-described selection and output are performed based on the specified value of L.

It is to be noted that, in the present Embodiment, the number of input frames are explained as 4 (=the square of 2) as an example for simplifying the description (the case where k=2 is described as a specific example). However, in the case where N is the power of 2, it is sufficient to include Log 2N (k blocks, N=2̂k) processing blocks (a first reproduction-calculation unit 621) It is to be noted that, the k+1 recording and calculating unit including the (k+1)th recording and calculating unit having the third decoding unit 601 is configured.

It is further to be noted that, the coding units 601, 604, and 609 may be shared when performance requirements are satisfied. Likewise, the subtracting units 606, 613, and 615 may also be shared when performance requirements are satisfied.

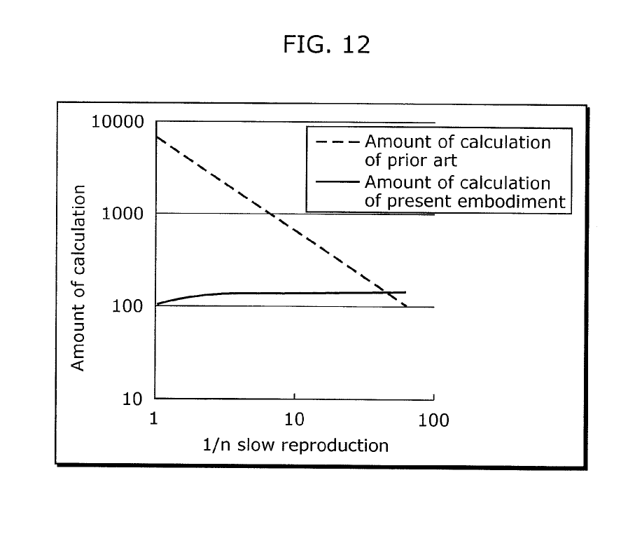

FIG. 12 is a diagram which shows a comparison of a computing amount in reproducing processing, between a prior art and the present Embodiment.

A computing amount of the prior art and a computing amount of the present embodiment are compared by assuming that the computing amount of each of the decoding units required for coding a single frame is 100, and the computing amount of each of the subtracting units required for subtracting a single added frame is 40, for example. As shown in FIG. 12, the computing amount of the present embodiment is considerably smaller than the computing amount of the prior art, as the reproduction speed becomes closer to the constant reproduction speed (the data in FIG. 12 placed further left) The reason for the above is that the processing of decoding a frame is carried out the same number of times as the number of frames to be reproduced according to the present embodiment (2̂(L−1) times in a unit time T), whereas all of the frames in a unit time T are simply decoded (2̂k frames are decoded) regardless of the reproduction speed (refer to L described above) according to the prior art, and thus the number of decoding performed according to the present embodiment is smaller than the number of decoding performed according to the prior art. Therefore, it is possible to perform reproducing using a reproducing device with insufficient performance. Further, it is possible to perform reproducing using a reproducing device with a simple configuration, thereby being used in a wider range of application. Furthermore, it is possible to contribute to lowering costs.

Further, since a moving picture is provided by using an added frame in which a frame suitable to the reproduction speed is added, it is possible to reconstruct a natural motion blur and to compensate underexposure, by adding the frame.

This makes it possible to obtain a high image quality with a smaller processing amount.

It is to be noted that, since the decoding unit, the subtracting unit, and the like can include plural number of decoding units, the subtracting units, and the like, respectively, parallel distributed processing is easily implemented, contributing to lower power consumption.

FIG. 9 is a configuration diagram of a video camera system 1.

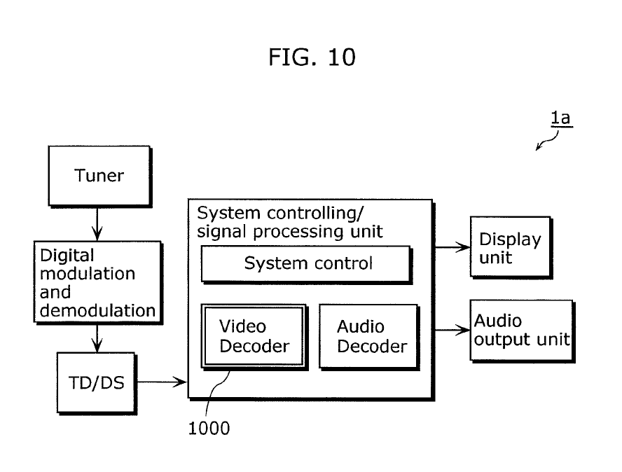

FIG. 10 is a configuration diagram of a digital television system 1a.

It is to be noted that, the video camera system 1 as shown in FIG. 9 is an example of a moving picture recording and reproducing device in which a video encoder (recording device) 900 including the recording unit 151 according to the present embodiment and a video decoder (reproducing device) 901 including the reproducing unit 171 are provided. Further, the digital television system 1a as shown in FIG. 10 is an example of a moving picture reproducing device in which a video decoder (reproducing device) 1000 including the recording unit 151 according to the present embodiment is provided. It is to be noted that, the video encoder (recording device) 900 may include the recording unit 151 and may be construed as a block rephrased from the recording unit 151. Likewise, the video decoder (reproducing device) 901 may include the reproducing unit 171 and may be a block rephrased from the reproducing unit 171. Further, the video decoder (reproducing device) 1000 may include the reproducing unit 171 and may be construed as a block rephrased from the reproducing unit 171.

The following provides the description. However, the following description is a mere example.

FIG. 9 shows a configuration of the video camera system 1.

The video camera system 1 includes: a video encoder 900; a video decoder 901; and a storage unit 902.

The video camera system 1 captures a moving picture in high speed imaging. Here, high speed imaging means imaging at a frame rate higher than 60 fps that is a normal frame rate, for example. It is to be noted that, 60 fps is a mere example of a normal frame rate. The typically frame rate may be construed as 29.97×2=59.94 fps based on the NTSC specification. The frame rate of the video camera system 1 for high speed imaging is, for example, (60×(2̂k))fps(k≧1). The high speed imaging at the frame rate of (60×(2̂k))fps is a 2̂k times high speed imaging.

Moving pictures captured in high speed imaging are generally reproduced more slowly when captured at higher speed. For example, when captured at a 2̂k times speed (2̂times frame rate), slow reproduction at 1/(2̂k) times speed is performed. In other words, each frame captured in a time interval shorter by 2̂k times is displayed in a time interval longer by 2̂k times than the time interval. With this, the time interval in which each frame is displayed is adjusted to the time interval suitable to human vision. Reproduction in a time interval longer by 2̂k times as described above, that is, 1/(2̂k) times slow reproduction is hereinafter called reproduction at normal slow speed.

The video encoder 900 (FIG. 9) codes a stream of a moving picture captured in high speed imaging.

The storage unit 902 stores a coded stream that has been coded.

The video decoder 901 receives an input of the coded stream of a moving picture captured in high speed imaging through such as an input of the coded stream stored in the storage unit 902, and decodes the coded stream that has been input.

FIG. 15 shows a configuration of the video encoder 900 (FIG. 9).

The video encoder 900 includes the recording unit 151 (FIG. 15 and FIG. 7) and a multiplexing unit 154.

The recording unit 151 receives an input of a record and input stream IS (FIG. 15) of a moving picture captured in high speed imaging, generates k+1 record-output streams obtained by coding the record and input stream IS that has been input, that is, the first record-output stream Va1 to the (k+1)th record-output stream Va3 (FIG. 15), and outputs the first record-output stream Va1 to the (k+1)th record-output stream Va3 which have been generated.

It is to be noted that, in the present embodiment, an example of a case where K=2, where video camera system performs high speed imaging of 2̂2=4 times speed.

FIG. 7 shows a configuration of the recording unit 151.

The recording unit 151 includes: an input unit 500; a first selecting unit 501; a first coding unit 504; a first adding unit 506; a second selecting unit 507; a second coding unit 510; a second adding unit 512; and the third coding unit 514.

Here, a t-th recording and calculating unit (the second recording and calculating unit 516 and the like) is configured by including all of the t-th selecting unit (the second selecting unit 507 and the like), the t-th coding unit (the second coding unit 510 and the like), and the t-th adding unit (the second adding unit 512 and the like) (1≦t≦k).

Further, a (k+1)th coding unit (third coding unit 514) is configured using the (k+1)th recording and calculating unit.

The t-th recording and calculating unit (1≦t≦k+1) receives an input of the t-th record-calculation-input stream. Then the t-th recording and calculating unit generates the t-th record-calculation-output stream based on the record-calculation-input stream that has been input, and outputs the record-calculation-output stream that has been generated. Here, the t-th record-calculation-output stream that is output is the t-th record-output stream Vat of the first record-output stream Va1 to the (k+1)th record-output stream (the third record-output stream Va3) (see FIG. 15) which have been output by the recording unit 151.

FIG. 5 indicates the t-th record-calculation-input stream (1≦t≦k+1).

The first record-calculation-input stream is the record and input stream IS (FIG. 5(1a)) that is input to the recording unit 151 (FIG. 5(1b)). The first record-calculation-input stream includes both the hatched frames of the first group in FIG. 5 (odd-numbered frame) and the non-hatched frames (even-numbered frame).

Also, the t-th record-calculation-input stream is the t-th group stream indicated in the t-th row in FIG. 5. Here, the t-th record-calculation-input stream (t-th group stream) includes both the hatched frames of the t-th group and the non-hatched frames.

The t-th record-calculation-input stream includes the a-th frame that is an added frame in which the (2×a)th frame and the (2×a+1)th frame of the t-th record-calculation-input stream are added (a is an integer). Further, the t-th record-calculation-input stream includes the a-th frame that is the a-th frame of the record and input stream IS.

Then, when the first record-calculation-input stream is reproduced at a normal slow speed, a moving picture is reproduced at a normal frame rate of 60 fps and the like. Also, when the t-th record-calculation-input stream is reproduced 2̂(t−1) times faster than the normal slow speed, reproduction at a normal frame rate is performed (1≦t≦k+1). The reproduction 2̂(t−1) times faster than the normal slow speed (slow reproduction at 1/(2̂k) speed) is called slow reproduction at (½̂ (k−(t−1))) speed (1≦t≦k+1). And, the reproduction 2̂((k+1)−1) times faster than the normal slow speed (2̂k times faster reproduction), that is, a reproduction of 1/1=1 times speed is called constant speed reproduction.

Further, the record and input stream IS of a moving picture captured in high speed imaging includes 2̂k frames in a unit time T. A reproduction which displays fewer than 2̂k frames to display a content of a moving picture in the unit times T is called decimation reproduction. Each of the slow reproduction at 1/(2̂(k−1)) speed (the slow reproduction at ½ speed) to the slow reproduction at 1/1 speed (reproduction at an constant speed) is decimation reproduction.

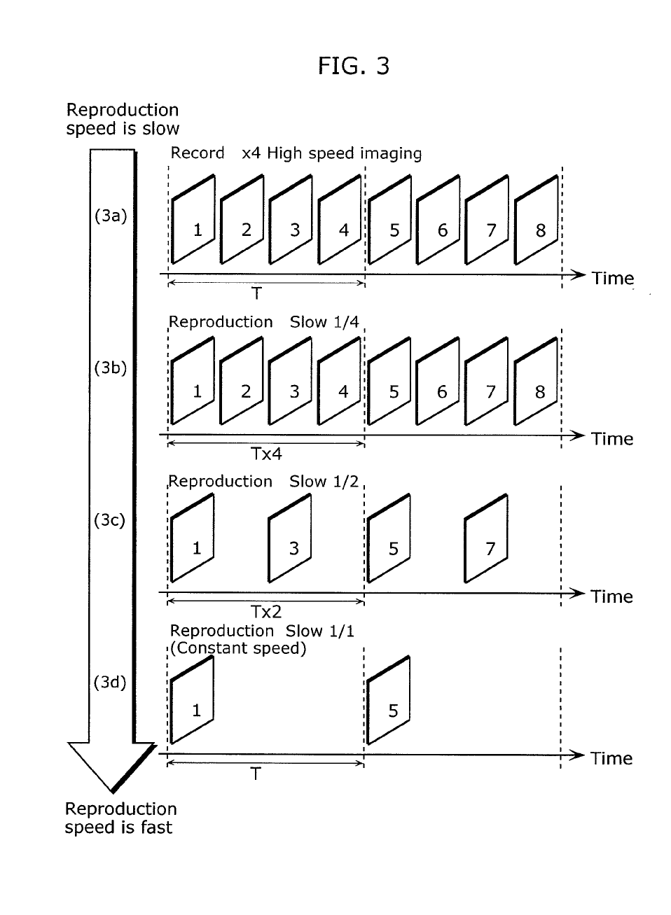

The t-th record-calculation-input stream is a stream that is reproduced through the slow reproduction at ½̂(k−(t−1)) speed by being reproduced. Further, each frame reproduced here is an added frame in which consecutive 2̂t frames in the record and input stream IS are added. Therefore, image quality higher than a case where merely one of 2̂t frames is reproduced (the prior art shown in FIG. 3) can be obtained, by preventing a lack of motion blur and the like,

It is to be noted that, the added frame, more specifically, may be a simple added frame in which each of the frames to be added to the added frame are added. Further, the added frame may be an average added frame that includes a value, as its value, obtained by dividing a value of the simple added frame by the number of the frames included in each of the added frames described above. When the added frame is the simple added frame, it is possible to avoid performing division, allowing preventing information from being missed, which is to be remainder from the division.

The input unit 500 inputs, to the first selecting unit 501 included in the first recording and calculating unit, the record and input stream IS that has been input into the recording unit 15, as the first record-calculation-input stream.

The (k+1)th coding unit (the third coding unit 514) codes each of the frames included in the (k+1)th record-calculation-input stream that is input into the (k+1)th recording and calculating unit by the k-th recording and calculating unit (the second recording and calculating unit 516), and generates the (k+1)th record-calculation-output stream including each of the coded frames. The a-th frame of the (k+1)th record-calculation-output stream is the a-th coded frame obtained by coding the a-th frame of the (k+1)th record-calculation-input stream.

It is to be noted here that, the i-th frame (i is an integer) is, for example, is a frame having an address obtained by adding a value i to an address of a predetermined reference frame (a frame at the beginning, for example) included in the stream that includes the i-th frame. For example, the (2×a−1)th frame is the odd-numbered frame of the stream, and the (2×a)th frame is the even-numbered frame.

The u-th selecting unit (1≦u≦k) identifies the (2×a−1)th frame (one frame, the hatched frame in FIG. 5) and the (2×a)th frame (the other frame, the non-hatched frame in FIG. 5), respectively, in each of the frames included in the u-th record-calculation-input stream that has been input into the u-th recording and calculating unit.

The u-th coding unit (1≦u≦k) codes the (2×a−1)th frame (the hatched frame in FIG. 5) identified by the u-th selecting unit. Then, the u-th coding unit generates the u-th record-calculation-output stream including the a-th coded frame obtained by coding the (2×a−1)th frame, as the a-th frame, and outputs the u-th record-calculation-output stream that has been generated. It is to be noted that, in FIG. 7, the first record-calculation-output stream Va1 and the second record-calculation-output stream Va2 are illustrated as the u-th record-calculation-output stream to be output.

The u-th adding unit adds the (2×a−1)th frame (the non-hatched remaining frame in FIG. 5) identified by the u-th selecting unit and the (2×a)th frame (the hatched frame in FIG. 5) to generate the a-th added frame. In FIG. 5, an arrow extending from the (2×a−1)th frame (frame 1, for example) and the (2×a)th frame (frame 2) to the a-th added frame (frame 1+2) obtained by adding those frames shows the processing of the addition. The u-th adding unit generates the u-th record-calculation-output stream that includes, as the a-th frame, the a-th added frame generated as described above. The u-th record-calculation-output stream that has been generated is input to the (u+1)th recording and calculating unit, as the (u+1)th record-calculation-input stream, by the u-th recording and calculating unit.

With this, the first recording and calculating unit to the (k+1)th recording and calculating unit outputs the first record-calculation-output stream to the (k+1)th record-calculation-output stream, respectively, which have the above-described configuration.

Then, the recording unit 151 outputs, to the multiplexing unit 154, the first record-calculation-output stream to the (k+1)th record-calculation-output stream which have been output as described above, as the first record-output stream Va1 to the (k+1)th record-output stream Va(k+1) (FIG. 15).

An audio encoding unit 152 (FIG. 15) codes audio data of an audio recorded by the video camera system 1 at the time of high speed imaging of the record and input stream IS that is input to the recording unit 151 is. The audio encoding unit 152 generates coded audio data obtained by coding the audio data and outputs the coded audio data that has been generated to the multiplexing unit 154. The multiplexing unit 154 generates the first moving picture stream 1551 to the (k+1)th moving picture stream 1553 (multiplex stream S1) based on the first record-output stream Va1 to the (k+1)th record-output stream Va(k+1) and the coded audio data which have been output from the multiplexing unit 154.

The first record-output stream Va1 to the (k+1)th record-output stream Va(k+1) which are output from the recording unit 151 are stored in the first moving picture stream 1551 to the (k+1)th moving picture stream 1553, respectively.

Further, each of the first moving picture stream 1551 to the (k+1)th moving picture stream 1553 stores the coded audio data generated by the audio encoding unit 152 (denoted by A indicated in the first moving picture stream 1151 and the like in FIG. 15). The coded audio data stored in the first moving picture stream 1551 to the (k+1)th moving picture stream 1553 includes content that is the same among each other.

It is to be noted that, one or all of the first moving picture stream 1551 to the (k+1)th moving picture stream 1553 may be a stream that includes a configuration according to a predetermined specification, such as the MPEG specifications.

The t-th moving picture stream according to the specification is reproduced by a reproducing device according to the specification. A general-purpose reproducing device reproduces each of record-output stream and coded audio data included in the u-th moving picture stream, thereby reproducing an image and audio of the record and input stream IS captured in high speed imaging. Then, when the t-th moving picture stream is reproduced by the general-purpose reproducing device (1≦t k+1), a display content in a unit time T is reproduced with 2̂(t−1) frames (refer to FIG. 5). When the first moving picture stream is reproduced by the general-purpose reproducing device, for example, the display content in the unit time T is displayed by reproduction of two frames.

It is to be noted that, as is described in detail below, when the multiplex stream S1 is reproduced by the video camera system 1, it is possible to reproduce the display content in the unit time T by reproduction of four frames. The video camera system 1 enables reproduction with higher image quality.

As described above, according to this embodiment, it is possible to perform reproduction with a low image quality using a general-purpose reproducing device, and thus reproduction can be performed by the general-purpose reproducing device.

It is to be noted that, according to this embodiment, each of the first moving picture stream 1551 to the (k+1)th moving picture stream 1553 stores coded audio data, as described above. Thus, it is possible to reproduce audio with a general-purpose reproducing device.

For example, the multiplexing unit 154 causes a storage medium (refer to FIG. 15) included in the storage unit 902 (FIG. 9) to store the multiplex stream S1 that has been generated.

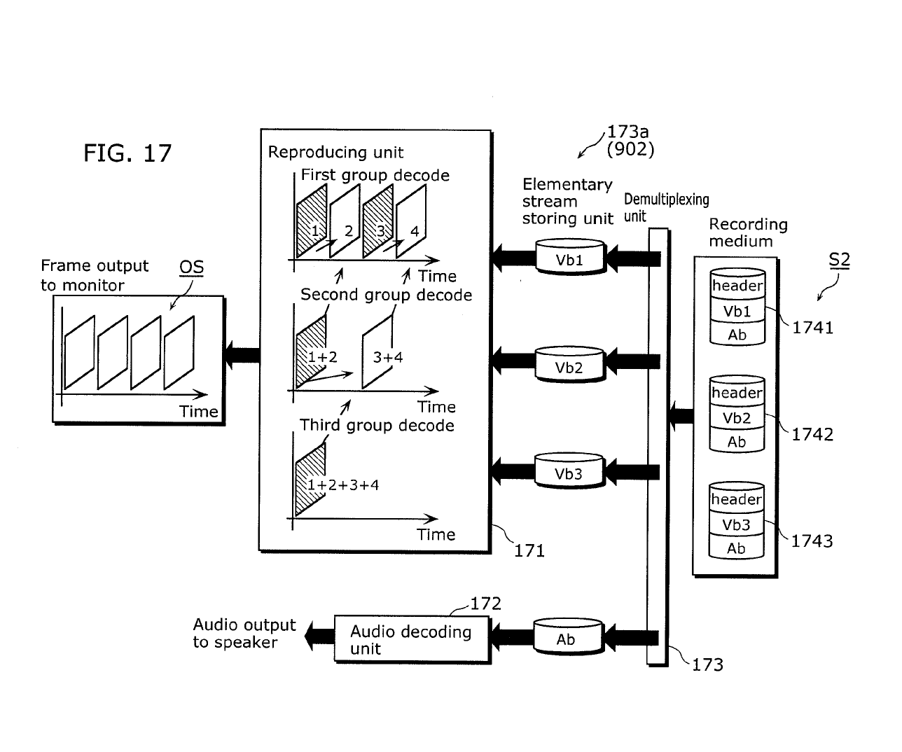

FIG. 17 shows a configuration of the video decoder 901 (FIG. 9).

The video decoder 901 includes: a demultiplexing unit 173; a reproducing unit 171; and an audio decoding unit 172.

A multiplex stream S2 is input into the video decoder 901. The multiplex stream S2 is, for example, the multiplex stream S1 generated by the video encoder 900 as described above. The multiplex stream S2 is data that has a data configuration the same as the data configuration of the multiplex stream S1. The video decoder 901, for example, obtains, from the storage unit 902, the multiplex stream S2 (the multiplex stream S1) stored in the storage unit 902 by the multiplexing unit 154, and inputs the obtained multiplex stream S2 into the video decoder 901.

The demultiplexing unit 173 specifies each of the first reproduce-calculate-input stream to the (k+1)th reproduce-calculate-input stream included in the multiplex stream S2 (refer to FIG. 17). Here, the first reproduce-input stream Vb1 to the (k+1)th reproduce-input stream Vb(k+1) is the above-mentioned first record-output stream Va1 to the (k+1)th record-output stream Va(k+1), and the like shown in FIG. 15.

Further, the demultiplexing unit 173 specifies coded audio data included in the multiplex stream S2.

To be more specific, the demultiplexing unit 173 specifies the first storing unit 1741 to the (k+1)th storing unit 1743 (the first storing unit 1551 to the (k+1)th storing unit 1553 in FIG. 15), for example, thereby specifying each of the first reproduce-input stream Vb1 to the (k+1)th reproduce-input stream Vb(k+1) included in the specified first storing unit 1741 to the (k+1)th storing unit 1743.

Further, more specifically, the demultiplexing unit 173 specifies coded audio data included in a storing unit that has been predetermined among the first storing unit 1741 to the (k+1)th storing unit 1743, for example.

Then, the demultiplexing unit 173 outputs each of the first reproduce-input stream Vb1 to the (k+1)th reproduce-input stream Vb(k+1) which have been specified, to the reproducing unit 171.

Further, the demultiplexing unit 173 outputs the coded audio data that has been specified, to the audio decoding unit 172 (FIG. 17).

FIG. 8 shows a configuration of the reproducing unit 171.

The reproducing unit 171 includes: a third decoding unit 601; a second decoding unit 604; a second subtracting unit 606; a second selecting unit 617; a first decoding unit 609; a first subtracting unit (the entire portions of a subtracting unit 613 and a subtracting unit 615); a first selecting unit (the entire portions of a selecting unit 610 and a selecting unit 618); and a selecting unit 619.

A u-th reproduction-calculation unit (the first reproduction-calculation unit 621, for example) (1≦u≦k) includes: a u-th decoding unit (the first decoding unit 609); a u-th subtracting unit (the first subtracting unit (the entire portions of the subtracting unit 613 and the subtracting unit 615)); and a u-th selecting unit (the selecting unit 610 and the selecting unit 618).

The (k+1)th decoding unit (the third decoding unit 601) is included in the (k+1)th reproduction-calculation unit (the third reproduction-calculation unit).

The t-th reproduction-calculation unit (1≦t≦k+1) receives an input of the u-th reproduce-input stream Vbt (described above) as the u-th reproduce-calculate-input stream Vbt from the above-described demultiplexing unit 173, generates a t-th reproduce-calculate-output stream based on the t-th reproduce-calculate-input stream Vbt that has been received, and outputs the t-th reproduce-calculate-output stream that has been generated. It is to be noted that, the u-th reproduce-input stream Vbt input into the reproducing unit 171 is the same as the t-th reproduce-calculate-input stream Vbt input into the t-th reproduction-calculation unit. A sign Vbt is assigned to all of the streams.

The t-th reproduce-calculate-output stream (1≦t≦k+1) is a reproduction stream for the slow reproduction at ½̂(k−(t−1)) speed. It is to be noted here that, the slow reproduction at ½̂(k−(t−1)) speed is a reproduction at an constant speed where t=k+1, and a reproduction at a normal slow speed where t=1.

The reproducing unit 171 selects the t-th reproduce-calculate-output stream (1≦t≦k+1) as a reproduce-output stream OS (FIG. 17) when the video camera system 1 performs a slow reproduction at ½̂(L−1) speed (L=k+1−(t−1)). Then, the reproducing unit 171 outputs, as the reproduce-output stream OS, the t-th reproduce-calculate-output stream that has been selected, thereby causing the video camera system 1 to reproduce the reproduce-output stream OS that is output.

Further, the audio decoding unit 172 decodes the coded audio data that has been input and outputs the decoded audio data, so that the decoded audio data is reproduced when the reproduce-output stream OS is reproduced.

FIG. 6 shows: a reproduce-calculate-output stream (a stream of a first group) of a normal slow speed, which is output by the third reproduction-calculation unit; a reproduce-calculate-output stream (a stream of a second group) of a slow speed of ½ times, which is output by the second reproduction-calculation unit; and a reproduce-calculate-output stream (a stream of a third group) of a constant speed, which is output by the first reproduction-calculation unit.

It is to be noted here that, each of the three reproduce-calculate-output streams includes both the hatched frame (odd-numbered frame) and the non-hatched frame (even-numbered frame) among the frames of the group corresponding to the reproduce-calculate-output stream.

It is to be noted that, the t-th reproduce-calculate-input stream Vbt (refer to FIG. 17, (1≦t≦k+1)) is a stream including a coded frame obtained by coding each of the hatched frames (odd-numbered frame) among the frames of the t-th group in FIG. 6.

The (k+1)th decoding unit (the third decoding unit 601) receives an input of the (k+1)th reproduce-calculate-input stream (the reproduce-input stream) Vb(k+1), that is, the third reproduce-calculate-input stream (the reproduce-input stream) Vb3 including the coded frame of each of the hatched frames of the third group in FIG. 5. Then, the (k+1)th decoding unit (the third decoding unit 601) decodes each of the coded frames included in the third reproduce-input stream (for example, the frame obtained by coding the frame 1+2+3+4), and generates the (k+1)th reproduce-calculate-output stream including each of the coded frames (the frame 1+2+3+4). In other words, the (k+1)th decoding unit generates the (k+1)th reproduce-calculate-output stream that includes, as a-th frame, the a-th decoded frame obtained by decoding the a-th frame of the third reproduce-input stream.

The t-th decoding unit (the second decoding unit 604, the first decoding unit 609, k+1−(L−1)≦t≦k, L≧2) decodes each of the (2×a−1)th frame of the t-th reproduce-calculate-input stream Vbt (for example, the frame obtained by coding the frame 1+2), and generates the t-th reproduce-calculate-output stream including, as the (2×a−1)th frame, the decoded frame obtained by decoding the a-th frame.

The t-th subtracting unit (the second subtracting unit 606, the third subtracting unit (the subtracting unit 613, the subtracting unit 615)) subtracts the (2×a−1)th frame of the t-th reproduce-calculate-output stream (for example, the frame 1+2) from the a-th frame included in the (t+1)th reproduce-calculate-output stream generate by the (t+1)th reproduction-calculation unit (for example, frame 1+2+3+4) to generate the frame (the frame 3+4) that is a resultant of the subtraction, as the (2×a)th frame of the t-th reproduce-calculate-output stream.

The t-th selecting unit (the first selecting unit (the selecting unit 610, the selecting unit 618), the second selecting unit 617) determines whether a current frame of the t-th reproduce-calculate-output stream that is output by the t-th reproduction-calculation unit is the (2×a−1)th frame or the (2×a)th frame. Then, the t-th selecting unit, when determined as being the (2×a−1)th frame, causes the decoded frame obtained by decoding the current frame (the a-th frame) of the t-th reproduce-calculate-input stream by the t-th decoding unit to be output as the current frame of the t-th reproduce-calculate-output stream (the (2×a−1)th frame). Further, the t-th selecting unit, when determined as being the (2×a)th frame, causes the frame that is the resultant of the subtraction of the current frame of the t-th reproduce-calculate-input stream performed by the t-th subtracting unit to be output as the current frame of the t-th reproduce-calculate-output stream (the (2×a)th frame). The selecting unit 619, when the video camera system 1 performs a slow reproduction at ¼ speed, for example, causes the recording unit 161 to output, as the first reproduce-output stream OS (FIG. 17), the first reproduce-calculate-output stream that is specified by the first recording and calculating unit. More specifically, the selecting unit 619, when the video camera system 1 performs a slow reproduction at 1/(2̂ (L−1)) speed, causes the (k+1−(L−1))th reproduce-calculate-output stream that is generated by the (k+1−(L−1))th recording and calculating unit to be output as the first reproduce-output stream OS (FIG. 17). The selecting unit 619 may obtain an input that specifies the value of the above-described L, which is input into the video camera system 1 by a user, for example, and cause an operation such as the operation of the reproducing unit 171 based on the value of L specified by the input that is obtained.

Further, the video camera system 1 may include a computer. Furthermore, the above-described functions of the video encoder 900 (refer to FIG. 15 and the like) may be implemented by executing, by the computer, a predetermined program. The same applies to the above-described functions of the video decoder 901 (refer to FIG. 17, and the like).

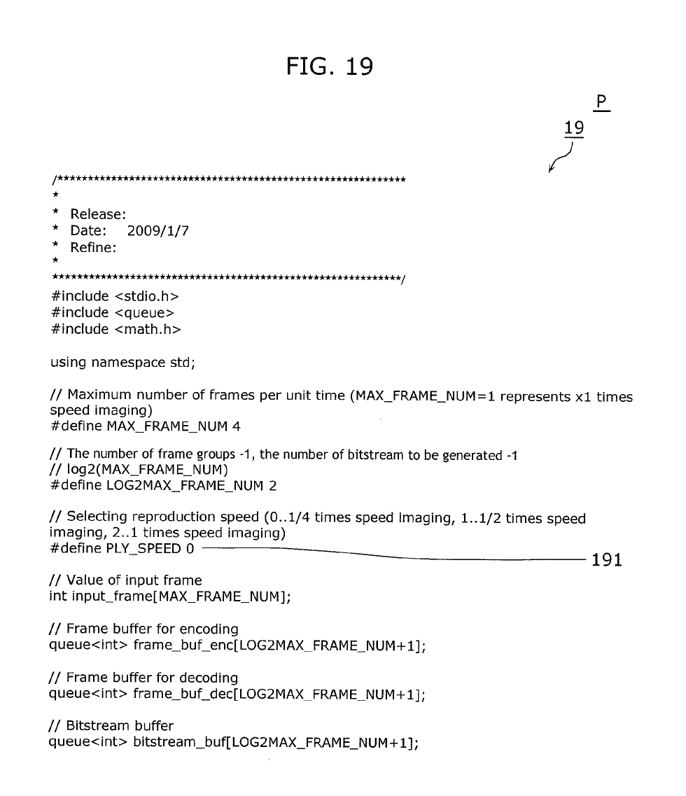

FIGS. 19 to 24 show a program P which illustrates an example of a program for implementing the functions of the video encoder 900 and the functions of the video decoder 901 by a computer. It is to be noted that, the following explains the details of the program P by using only diagrams for simplicity, and complicated explanations using sentences are omitted. In the following descriptions, writing specified processing on a specified portion of the program P is referred to as performing the specified processing by the specified portion.

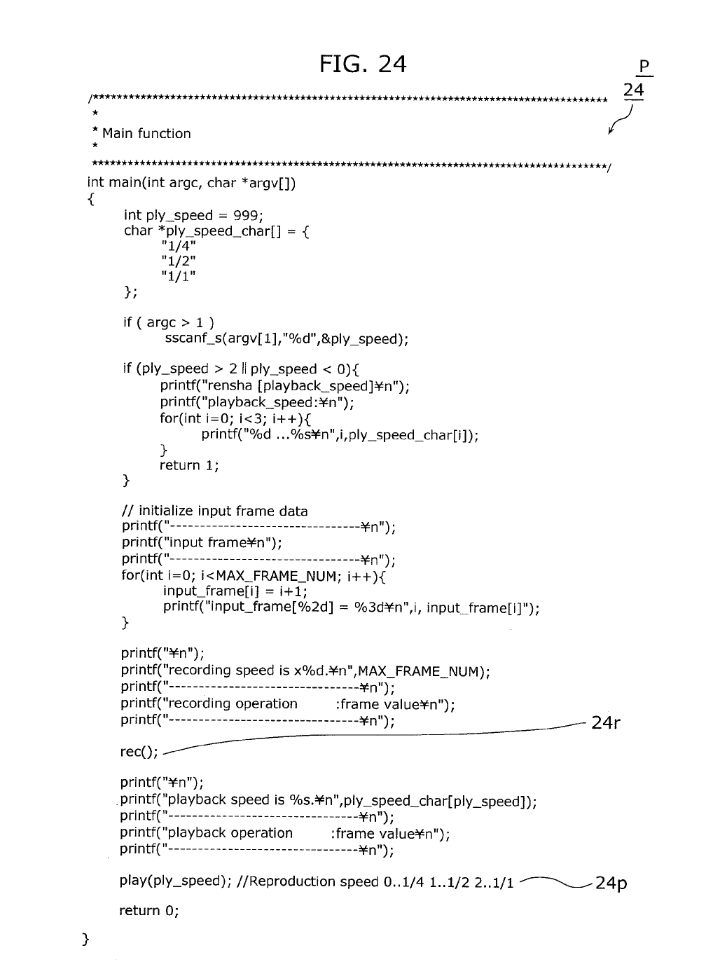

FIG. 24 is a diagram which shows a configuration of a main portion 24 of the program P.

The main portion 24 is a portion of the program P, which performs processing first, when a computer that executes the program P starts execution of the program P.

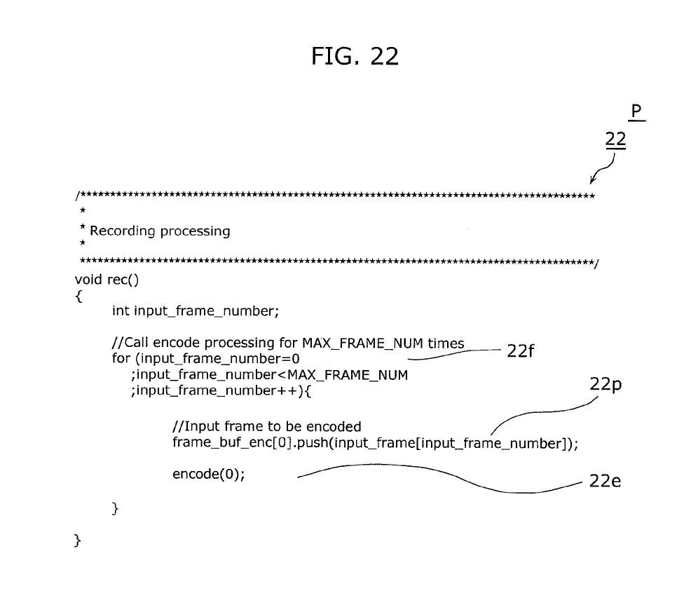

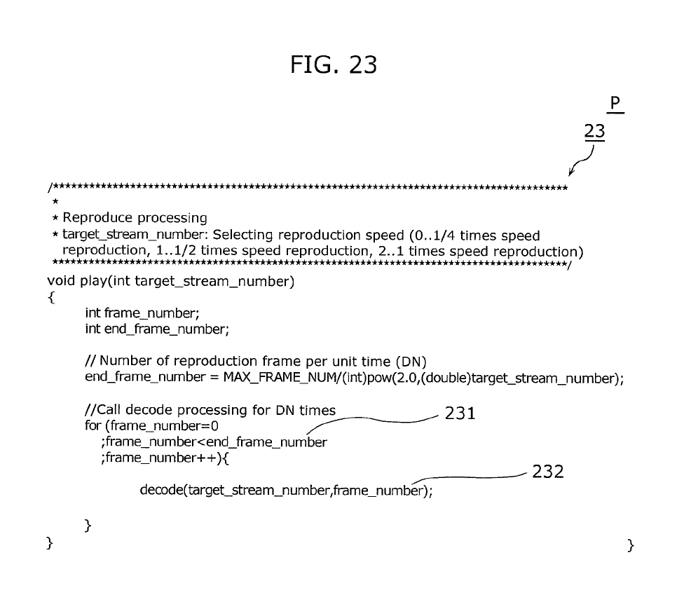

The main portion 24 includes a recording processing calling portion 24r and a reproducing processing calling portion 24p. The recording processing calling portion 24r causes a computer to start a processing of the recording processing portion 22 (FIG. 22). The reproducing processing calling portion 24p causes a reproducing processing portion 23 (FIG. 23) to be executed. It is to be noted that, other portions included in the main portion 24 are indicated only by the diagrams.

FIG. 22 is a diagram which shows a configuration of the recording processing portion 22 whose execution is started by the recording processing calling portion 24r (FIG. 24).

The recording processing portion 22 includes: a completion determining portion 22f; a frame obtaining portion 22p; and an encoding calling portion 22e.

The completion determining portion 22f determines whether or not the recording processing portion 22 has completed a processing of predetermined plural frames among the frames of the record and input stream IS (FIG. 15 and the like) of a moving picture that has been captured. Then, the completion determining portion 22f causes a processing of the frame obtaining portion 22p and the like to be continued until completion is determined. More specifically, the completion determining portion 22f determines whether or not a processing of plural frames captured in a predetermined unit time has been competed, for example. In the example of the program P, to be specific, it is determined whether or not the processing of the number of frames defined by a #define statement of MAX_FRAME_NUM of a header portion of the program P (FIG. 19, later described) has been completed.

The frame obtaining portion 22p specifies a top of frames (focus frame) whose processing is not completed by the recording unit 151, among the frames of the record and input stream IS. Then, to be specific, in the example of the program P, the frame obtaining portion 22p stores the specified focus frame into a predetermined storage area (a storage area of the top of frame_buf_enc[ ]).

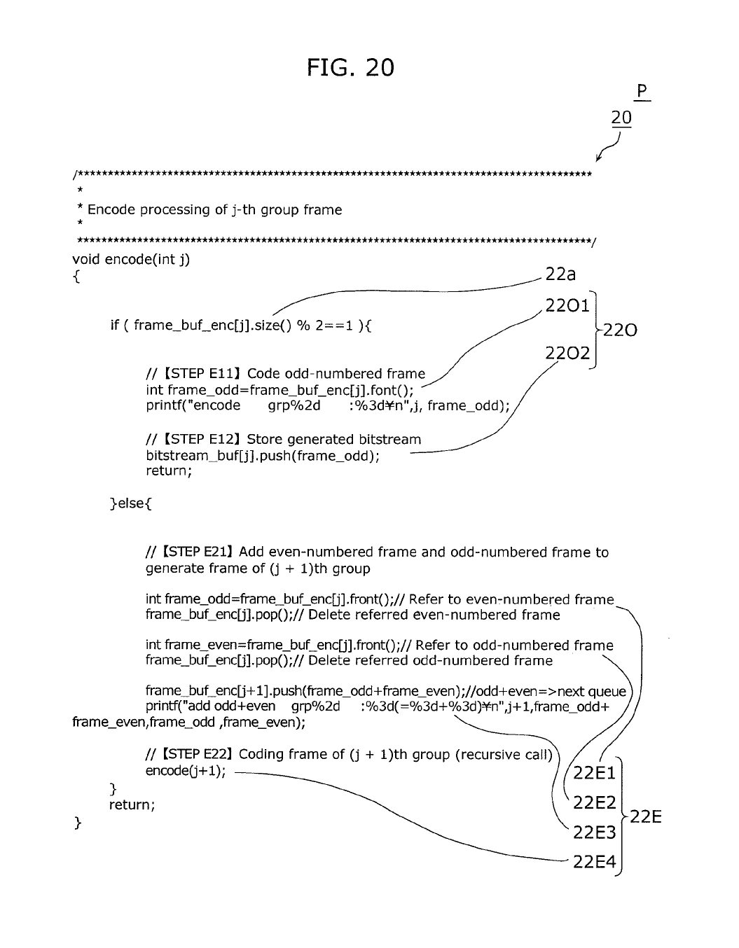

The encoding calling portion 22e causes a processing of an encoding processing portion 20 (FIG. 20) to be started

FIG. 20 is a diagram which shows a configuration of the encoding processing portion 20 that is caused to start a processing by the encoding calling portion 22e (FIG. 22).

The encoding processing portion 20 includes an argument j used when the processing is started. The argument j specifies, as t=j+1, t of the t-th record-output stream that is handled by the encoding processing portion 20 in the processing started. The recording processing calling portion 24r of the main portion 24 (FIG. 24) causes the encoding processing portion 20 to start the processing by using an argument 0(t=0+1=1). Further, the argument of J≧1 is used by an other frame processing portion 22E (described later) of the encoding processing portion 20, and the other frame processing portion 22E starts the processing.

The encoding processing portion 20 includes; a frame determining portion 22a; a coding side frame processing portion 220; and the other frame processing portion 22E.

The frame determining portion 22a determines whether or not the focus frame specified by the frame obtaining portion 22p (FIG. 22) is an odd-numbered frame (the (2×a−1)th frame) of the t-th record-calculation-input stream, among the frames (each of the hatched and non-hatched frames of the t-th group in FIG. 5) of the t-th record-calculation-input stream (t=j+1). More specifically, the frame determining portion 22a determines whether or not the number of frames that are stored in the predetermined storage area (frame_buf_enc[j] of the program P) in which each of the frames of the t-th record-calculation-input stream is stored is an odd-number (refer to a conditional expression of frame_buf_enc[j]. size%2==1 of the program P.). Further, the frame obtaining portion 22p in FIG. 22 stores the focus frame specified by the frame obtaining portion 22p at the beginning of the storage area of the first record-calculation-input stream. Then, the frame determining portion 22a determines that the focus frame is an odd-numbered frame when the number of the frames stored is an odd-number. It is to be noted that, as described in detail later, when the frame stored in the predetermined storage area described above is deleted (discarded), an even-numbered frame that corresponds to the frame is deleted together with the frame. This prevents a false determination resulting from the deletion.

The coding side frame processing portion 220 performs a processing of the case where the focus frame is determined as being the (2×a−1)th frame by the above-descried frame determining portion 22a. The coding side frame processing portion 220, for example, performs a processing of the case where the focus frame is determined as being the (2×a−1)th frame when t=1(j=0), in the case where the focus frame is the frame 1 in FIG. 5.

Then, the coding side frame processing portion 220 includes a coding portion 2201 and an output portion 2202.

The coding portion 2201 codes the focus frame (the (2×a−1)th frame). It is to be noted that, in the coding portion 2201 of the program P indicated in FIG. 20, the coding processing is configured schematically.

The output portion 2202 specifies a coded frame (frame_odd) that has been coded by the coding portion 2201, as a current frame of the t-th record-output stream (t=j+1 of the program P). To be specific, the processing of the output is indicated schematically by the processing of storing the coded frame in the storage area bitstream_buf[j].

The other frame processing portion 22E performs a processing of the case where the obtained frame is determined as being the even-numbered frame (the (2×a)th frame) by the frame determining portion 22a.

The other frame processing portion 22E includes: an other frame obtaining portion 22E1; a coding side frame obtaining portion 22E2; an adding portion 22E3; and a next stream processing calling portion 22E4.

The other frame obtaining portion 22E1 obtains the determined frame (the (2×a)th frame).

The coding side frame obtaining portion 22E2 obtains an odd-numbered frame (the (2×a−1)th frame) that corresponds to the determined frame (the (2×a)th frame).

It is to be noted that, at this time, the other frame obtaining portion 22E1 and the coding side frame obtaining portion 22E2 deletes (discards), from the above-descried storage area frame_buf_enc[j], the obtained the (2×a)th frame and the (2×a−1)th frame, respectively. As described above, not one of, but both of the pair of the (2×a)th frame and the (2×a−1)th frame are deleted simultaneously. Thus, even when the frame is deleted, the frame determining portion 22a does not make a false determination (as described above).

The adding portion 22E3 adds the (2×a−1)th frame obtained by the other frame processing portion 22E and the (2×a)th frame obtained by the coding side frame obtaining portion 22E2. It is to be noted that, in the example of the program P, the processing of the addition is indicated schematically.

Then the adding portion 22E3 specifies the added frame that is a resultant of the addition as a focus frame of a processing that handles the (t+1)th record-output stream started by the next stream processing calling portion 22E4 that is described later. To be specific, the adding portion 22E3 performs the specifying by storing the added frame into the predetermined storage area (at the beginning of frame_buf_enc[j+1]), as shown in FIG. 20. The next stream processing calling portion 22E4 causes the encoding processing portion 20 (FIG. 20) to start the processing of handling the (t+1)th record-output stream. Thus, the next stream processing calling portion 22E4 uses j+1 as an argument when causing the processing to be started, as shown in FIG. 20. In the processing that is started, the processing that is specified by the adding portion 22E3 in advance and based on the focus frame is performed by the encoding processing portion 20.

It is to be noted that, the definition of MAX_FRAME_NUM in FIG. 19 may be 8 instead of 4, for example. In this case, the frame 5+6+7+8 is the second frame (the (2×a)th frame) of the (k+1)th record-calculation-input stream.

Then, the other frame processing portion 22E, in the case where t=k+1, that is, j+1=k+1, may determine that the focus frame is the (2×a−1)th frame, regardless of the focus frame being the (2×a−1)th frame or the (2×a)th frame. At this time, the frame 5+6+7+8 is coded by the coding side frame obtaining portion 22E2.

The number of the recording and calculating unit (k+1) is k+1=Log 2N (Log 2N is a base 2 logarithm) when the frame rate of high speed imaging is N times the normal frame rate (N=4, in the example of FIG. 5 and the like), for example. With this, the (k+1)th record-calculation-input stream includes one frame. Thus, the frame 5+6+7+8, for example, is not the (2×a)th frame (even-numbered frame), but the (2×a−1)th frame (odd-numbered frame). Therefore, as described above, the other frame processing portion 22E does not have to perform an exceptional processing when t=k+1, and thus it is possible to simplify the processing.

It is to be noted that, the entire first selecting unit 501 and the second selecting unit 507 may be construed as corresponding to, for example, the frame determining portion 22a (for example, having the same function). Further, the entire first adding unit 506 and the second adding unit 512 may be construed as corresponding to, for example, the adding unit 22E3 in FIG. 20. The entire first coding unit 504, the second coding unit 510; and the third coding unit 514 may be construed as having the function corresponding to, for example, the coding portion 2201 in FIG. 20.

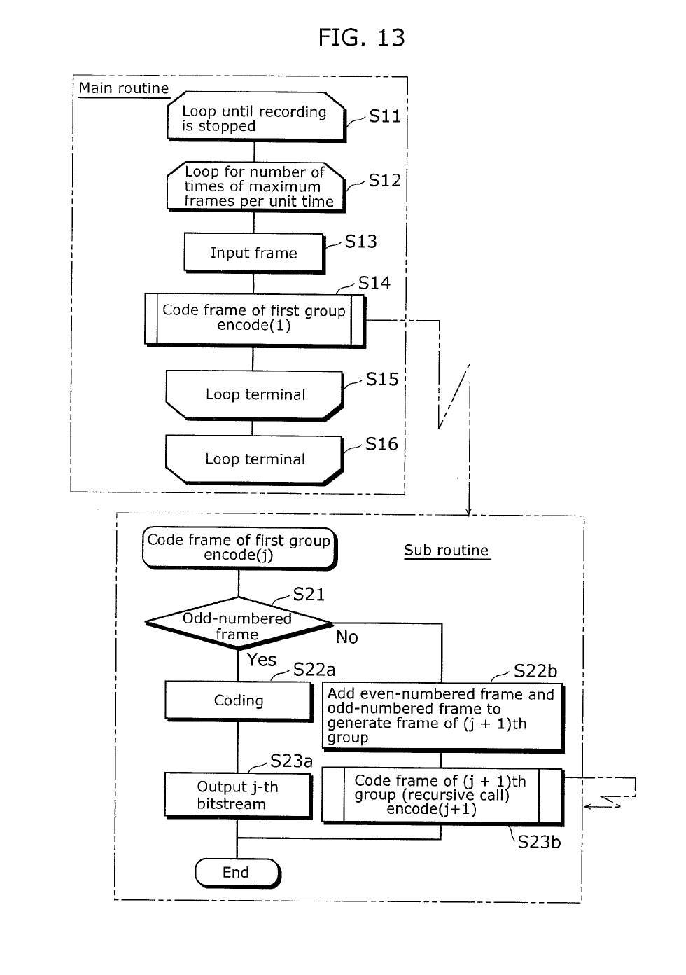

FIG. 13 is a flow chart of a processing of a program P.

In Step S11 (Step S15), whether or not a recording processing is stopped is determined, and when it is not determined to stop, the processing of Steps S12 to S15 are repeatedly executed. It is determined to stop, for example, in the case where a predetermined input for causing stop is input into the computer by a user, and the like It is to be noted that, the program P may include a stop control portion (not illustrated) that performs the processing of Step S11 (Step S15), for example.

In Step S12 (Step S16), a repeat control portion (the portion of for (input_frame . . . )) of the recording processing portion 22 (FIG. 22) causes the frame obtaining portion 22p and the encoding calling portion 22e (FIG. 22) to perform the processing of the block for the number of times that is the number of frames in the unit time (T) (MAX_FRAME_NUM of FIG. 19).

In Step S13, the frame obtaining portion 22p (FIG. 22) specifies the focus frame.

In Step S14, the encoding calling portion 22e (FIG. 22) causes the encoding processing portion 20 (FIG. 20) to start the processing of handling the first record-calculation-output stream for the focus frame specified in Step S13.

Step S21 and the like indicate the processing performed by the encoding processing portion 20.

In Step S21, the frame determining portion 22a determines whether or not the focus frame is the (2×a−1)th frame (an odd-numbered frame).

In Step S22a, the coding portion 2201 of the coding side frame processing portion 220 codes the focus frame in the case where the focus frame is determined as being the (2×a−1)th frame (an odd-numbered frame) in Step S21.

In Step S23a, the output portion 2202 outputs the coded frame that is coded in Step S22a, as a current output frame of the t(=j+1)th record-output stream (refer to FIG. 5).

In Step S22b, in the case where it is determined in Step S21 that the focus frame is not the (2×a−1)th frame (the odd-numbered frame) (Step S21: NO), that is, determined to be the (2×a)th frame (the even-numbered frame), the other frame processing portion 22E adds two frames as described above by using the adding portion 22E3 of the other frame processing portion 22E.

In Step S23b, the other frame processing portion 22E causes the encoding processing portion 20 to start the processing of outputting the (t+1)th record-calculation-output stream, with the added frame that is a resultant of the addition in Step S22b being the focus frame, by using the next stream processing calling portion 22E4.

FIG. 19 is a diagram which shows a configuration of a header portion 19 of the program P.

The header portion 19 includes a reproduction speed specifying portion 191. The reproduction speed specifying portion 191 specifies constant number L described later which is used by the video camera system 1 when performing slow reproduction at ½̂(L−1) speed (described above). To be specific, in the example of the program P, the reproduction speed specifying portion 191 schematically indicates with the #define statement, an example of specifying a value of L using the function of a preprocessor. It is to be noted that, the reproduction speed specifying portion 191 may obtain an input that specifies the value of L by a user, for example.

FIG. 23 is a diagram which shows a configuration of the reproducing processing portion 23 that is called by the reproducing processing calling portion 24p (FIG. 24) of the main portion 24.

The reproducing processing portion 23 includes target_stream_number that is an argument used for starting the processing. The argument target_stream_number specifies the value of the above-described L as L=(k+1)−target_stream_number. More specifically, the reproducing processing portion 23 generates a record-calculation-output stream of the record-output stream (the (k+1−(L−1))th) for slow reproduction at ½̂(L−1) speed that corresponds to the value of the specified L, and outputs the record-output stream that has been generated.

The reproducing processing portion 23 includes: an activating portion 231; and the decoding processing calling portion 232.

The activating portion 231 sequentially selects each frame of the (k+1−(L−1))th reproduce-calculate-output stream as described above, and causes the decoding processing calling portion 232 to start a processing of the selected frame (focus frame).

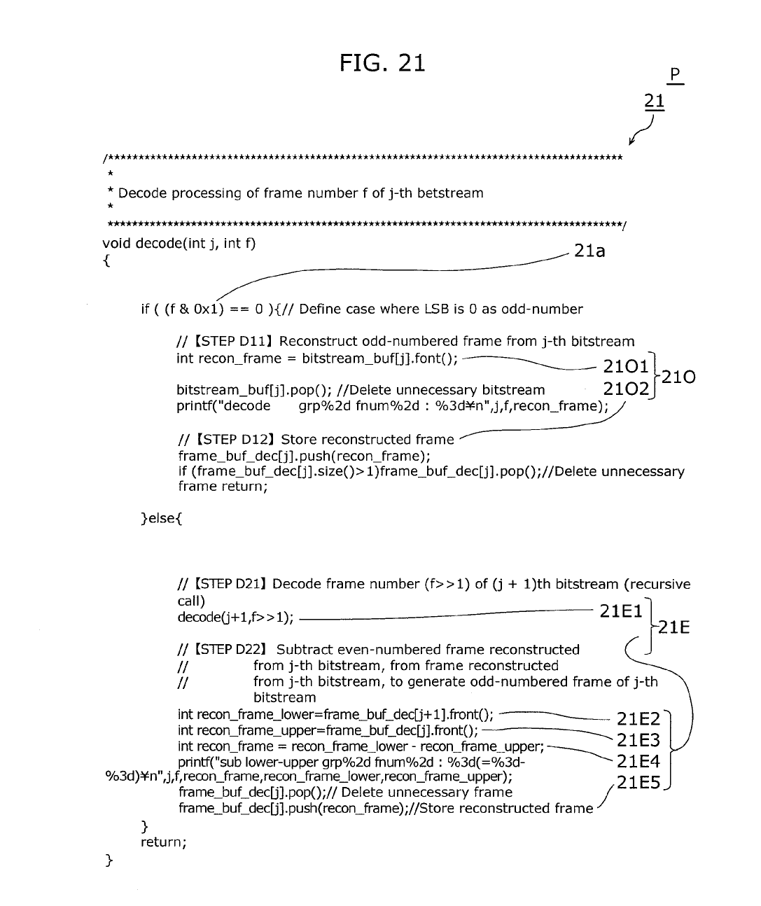

The decoding processing calling portion 232 causes the decoding processing portion 21 (FIG. 21) to start a processing of the (k+1−(L−1))th reproduce-calculate-output stream on the focus frame that has been selected by the activating portion 231. Here, the (k+1−(L−1))th reproduce-calculate-output stream is a stream that is output from the recording unit 161 as described above.

FIG. 21 is a diagram which shows a configuration of the decoding processing portion 21 that is called by the decoding processing calling portion 232 (FIG. 23).

The decoding processing calling portion 232 receives the argument j and the argument f.

The argument j specifies the t-th record-calculation-input stream that is processed by the decoding processing calling portion 232, as the (j+1)th record-calculation-input stream. The decoding processing calling portion 232 described above, for example, uses the argument j={k+1−(L−1)}−1=k+1−L (=target_stream_number of FIG. 23), to start the processing of the (k+1−(L−1))th reproduce-calculate-output stream.

The argument f specifies the focus frame. To be specific, the argument f is an address, in the t-th record-calculation-input stream, of the focus frame (order, frame number).

The decoding processing portion 21 includes; a frame determining portion 21a; a decoding side frame processing portion 210; and the other frame processing portion 21E.

The frame determining portion 21a determines whether or not the focus frame is the (2×a−1)th frame (the odd-numbered frame) in the t-th record-calculation-input stream that is processed by the decoding processing portion 21. To be specific, the frame determining portion 21a performs determination by determining whether or not the least significant bit (f & 0x1) of the frame number of the focus frame is 0, as shown in FIG. 21.

The decoding side frame processing portion 210 performs processing of the focus frame in the case where the frame determining portion 21a determines that the focus frame is the (2×a−1)th frame (the odd-numbered frame) (f & 0x1==0).

Then, the decoding side frame processing portion 210 includes an obtaining portion 2101 and a decoding portion 2102.

The obtaining portion 2101 obtains the focus frame (the frame obtained by coding the hatched frame in FIG. 6).

The decoding portion 2102 decodes the coded frame obtained by the obtaining portion 2101. In this example, the decoding processing is indicated schematically.

The other frame processing portion 21E performs the processing in the case where it is determined that the focus frame is the (2×a)th frame (the even-numbered frame).

The other frame processing portion 21E includes: a next stream processing calling portion 21E1; an added frame obtaining portion 21E2; a decoding side frame obtaining portion 21E3; a subtracting portion 21E4; and an output portion 21E5.

The next stream processing calling portion 21E1 causes the decoding processing portion 21 to start a processing using the (t+1)th record-calculation-input stream, which is a processing that generates the added frame (the frame 1+2) of the focus frame (the frame 2 in FIG. 6, for example). With the processing started, the added frame (the frame 1+2) of the focus frame is generated by the decoding processing portion 21. Here, the next stream processing calling portion 21E1 starts the processing that uses the (t+1)th record-calculation-input stream as described above. Thus, the next stream processing calling portion 21E1 uses a value (j+1) that specifies t+1, as the argument j. Further, the added frame that is generated is the a-th frame in the (t+1)th record-calculation-output stream, whereas the focus frame is the (2×a)th frame in the t-th record-calculation-input stream. Thus, the next stream processing calling portion 21E1, when starting the processing, uses a value that specifies “a”, that is f/2(f≧≧1), as an argument f. Here, “f≧≧1” indicates the value obtained by shifting f to the right by one bit, and the number obtained by dividing f by 2.

The added frame obtaining portion 21E2 obtains the added frame (the frame 1+2 in FIG. 6, for example) generated in the processing started by the next stream processing calling portion 21E1.

The decoding side frame obtaining portion 21E3 obtain a decoded frame obtained by decoding the (2×a−1)th frame of the t-th reproduce-calculate-input stream.

The subtracting portion 21E4 subtracts the decoded frame obtained by the decoding side frame obtaining portion 21E3 from the added frame obtained by the added frame obtaining portion 21E2, and specifies the subtracted frame as the focus frame (the (2×a)th frame).

The output portion 21E5 outputs the specified focus frame.

It is to be noted that, the entire first decoding unit 609, second decoding unit 604, and third decoding unit 601 may be construed as corresponding to the decoding portion 2102 (FIG. 21), for example. Further, the entire second subtracting unit 606 and first subtracting unit (the subtracting unit 613 and the subtracting unit 615) may be construed as corresponding to the subtracting portion 21E4, for example. Further, the entire selecting unit 617, selecting unit 610, selecting unit 618, and selecting unit 619 may be construed as corresponding to the frame determining portion 21a, for example.

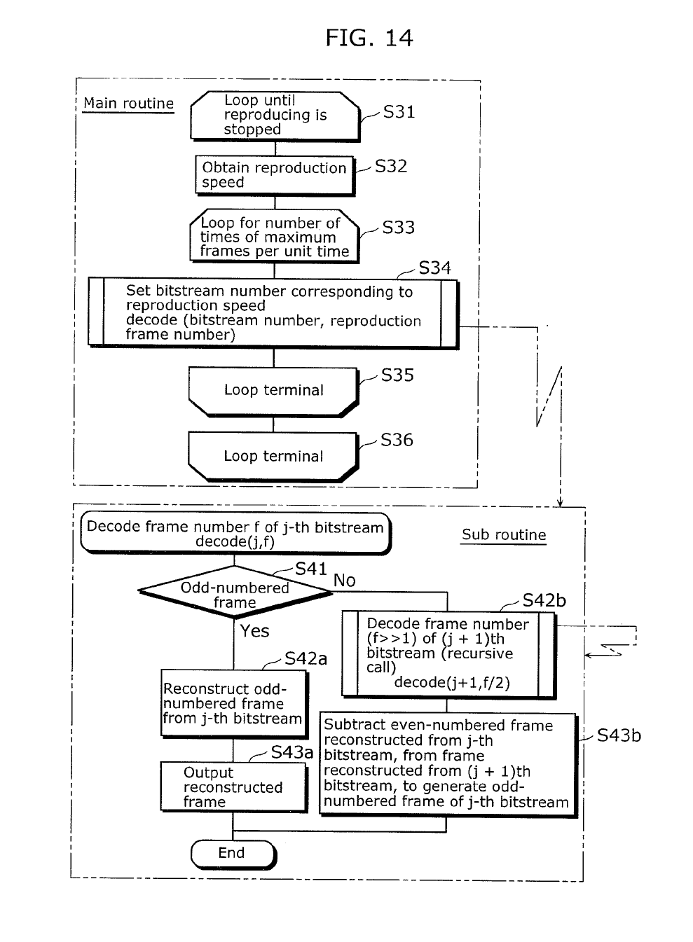

FIG. 14 is a flow chart of a processing performed by the reproducing unit 171 according to the program P.

In Step S31 (Step S36), a processing of determining whether or not the reproduction process is discontinued and the like, is performed by, for example, the stop control portion described above (Step S11 in FIG. 13 and the like).

In Step S32, the reproducing processing portion 23 (FIG. 23) obtains the value of L specified by the reproduction speed specifying portion 191 (FIG. 19). To be specific, the reproducing processing portion 23 obtains the argument target_stream_number that specifies the value of L, thereby obtaining the value of L.

In Step S33 (Step S35), the activating portion 231 (FIG. 23) sequentially select a frame and causes the selected frame (focus frame) to be processed.

In Step S34, the decoding processing calling portion 232 causes the decoding processing portion 21 to perform a processing for the focus frame selected in Step S33, which uses the (k+1−(L−1))th reproduce-calculate-input stream indicated by L specified in Step S32.

Step S41 and the like indicate the processing performed by the decoding processing portion 21.

In Step S41, the frame determining portion 21a determines whether or not the focus frame is the (2×a−1)th frame.

In Step S42a, the decoding side frame processing portion 210 decodes the focus frame in the case where the focus frame is determined as being the (2×a−1)th frame (an odd-numbered frame) (Yes in Step S41).

In Step S43a, the decoding side frame processing portion 210 stores the decoded frame that has been decoded in Step S42a.

In Step S42b, the next stream processing calling portion 21E1 causes the decoding processing portion 21 to perform the processing of generating the added frame described above, in the case Where it is determined in Step S41 that the focus frame is the (2×a)th frame (even-numbered frame) (Step S41: No).

In Step S43b, the added frame obtaining portion 21E2, the decoding side frame obtaining portion 21E3, the subtracting portion 21E4, the output portion 21E5, and the like perform various processing such as subtraction, based on the added frame that has been generated in Step S42b.

It is to be noted that, although an example of performing recursive processing is provided for convenience in the example, a program that does not execute recursive processing may be configured.

FIG. 10 shows a digital television system 1a.

The digital television system 1a includes a video decoder 1000. The video decoder 1000 has a function same as the function of the above-described video decoder 901, such as a configuration of FIG. 7. Modifications according to the digital television system 1a of FIG. 10 may be implemented.

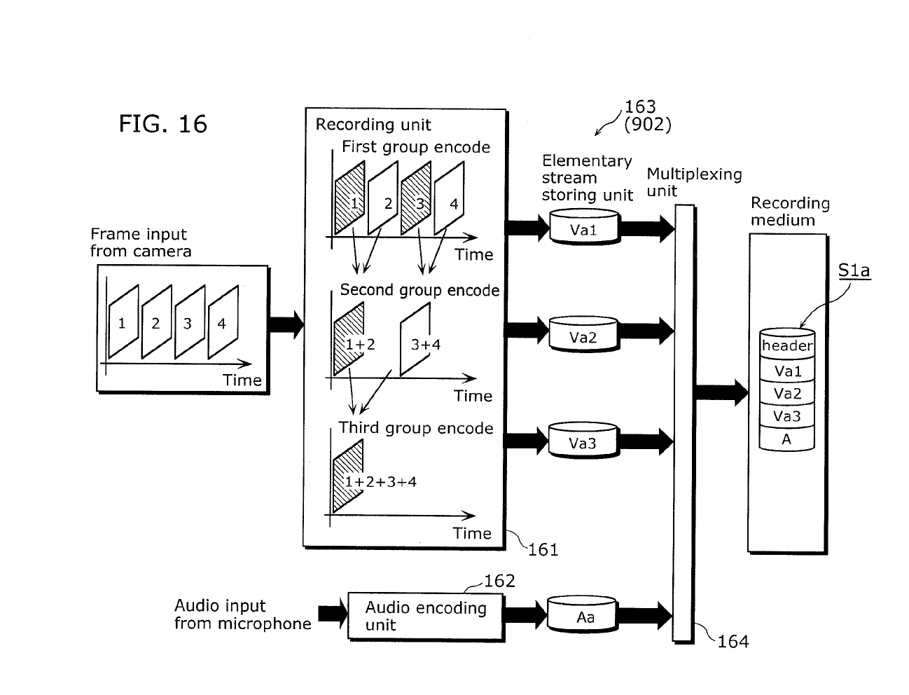

FIG. 16 is a diagram which shows a multiplex stream S1a.

The multiplex S1a includes plural holding units. The multiplex stream S1a is, for example, a stream of a multi-scene (multi channel, multi angle) that is a stream whose plural holding units respectively holds moving pictures from plural view points.

The first holding unit to the (k+1)th holding unit are a part or all of the plural holding units included by the multiplex stream S1, each of which holds a corresponding one of the first record-output stream Va1 to the (k+1)th record-output stream Va (k+1). It is to be noted that, each of the first holding unit to the (k+1)th holding unit includes, for example, a time stamp of the frame of the record-output stream that is held. The time stamp specifies a frame of another record-output stream of the same time as the time of the frame.

Then the multiplex stream S1a includes an audio recording unit that stores coded audio data, together with the plural holding units (refer to a symbol A in FIG. 16).

It is to be noted that, the multiplex stream S1a, to be specific, may have, for example, a multi-scene format according to the MPEG (Moving Picture Experts Group) specifications, and may include the audio recording unit according to the MPEG specifications.

With this, by reproducing a record-output stream and coded audio data of the u-th holding unit with a general-purpose reproducing device that reproduces a stream in a multi-scene format, it is possible to easily reproduce moving pictures with a general-purpose reproducing device, although the image quality is comparatively lowered, as with the above-described case.

The multiplexing unit 164 generates the multiplex stream S1a from the first record-output stream to the (k+1)th record-output stream which are output by the recording unit 161.

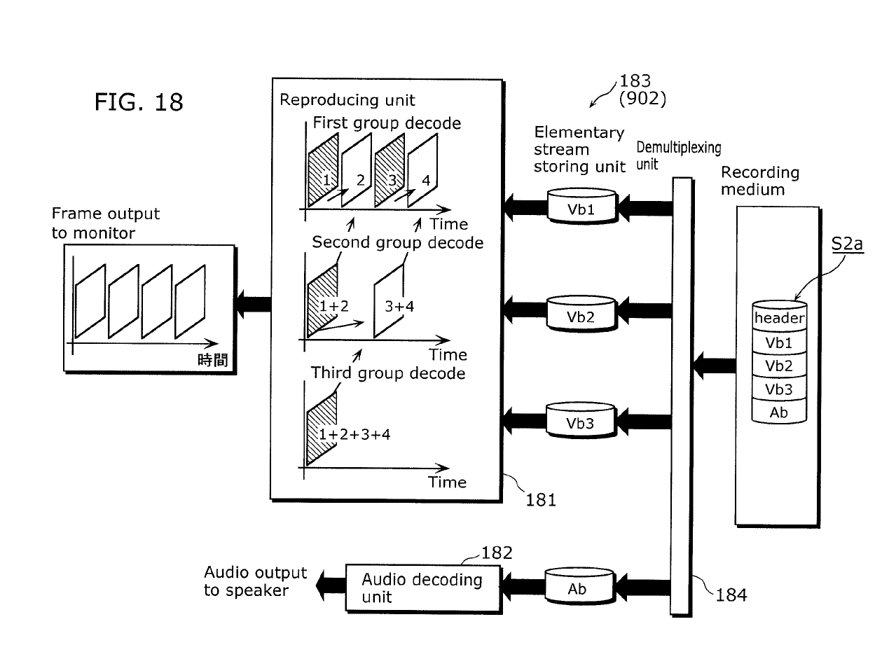

FIG. 18 is a diagram which shows a multiplex stream S2a that is input into the video decoder 901 (FIG. 9). The multiplex stream S2a is, for example, the multiplex stream S1a described above, and has the data configuration same as the data configuration of the multiplex stream S1a.

The demultiplexing unit 184 generates the first reproduce-input stream Vb 1 to the (k+1)th reproduce-input stream Vb(k+1) from the multiplex stream S1a, and inputs, into the reproducing unit 181, the first reproduce-input stream Vb 1 to the (k+1)th reproduce-input stream Vb(k+1) which have been generated. It is to be noted that, the generated first reproduce-input stream to the (k+1)th reproduce-input stream are, for example, the first record-output stream Va1 to the (k+1)th record-output stream Va (k+1) (refer to FIG. 16).

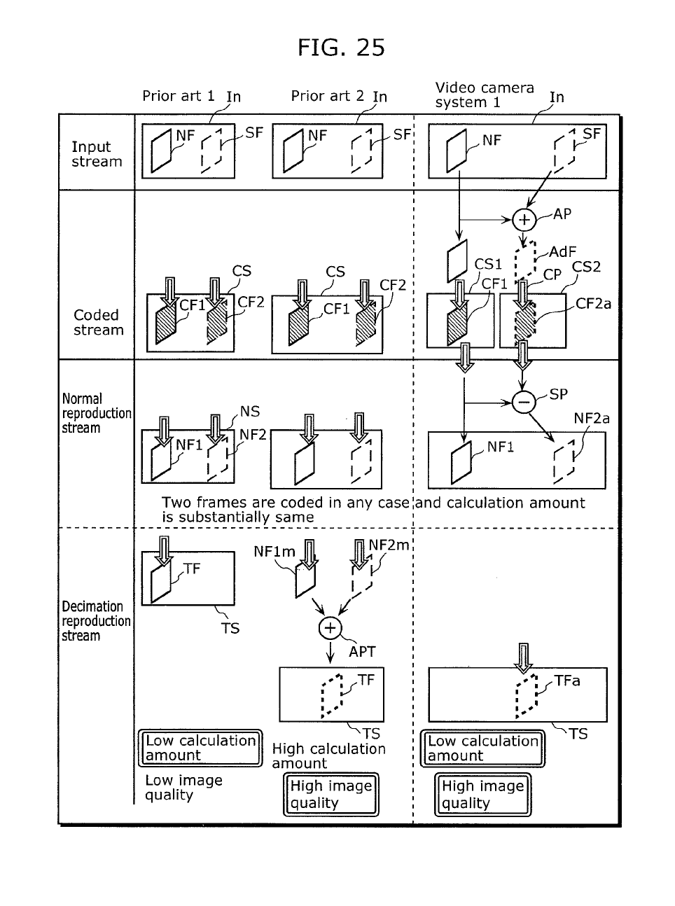

FIG. 25 is a diagram which shows an operation of the video camera system 1. In FIG. 25, the operation of the video camera system 1 is shown in the third column of the diagram in FIG. 25.

The first row in the diagram of FIG. 25 indicates the u-th record-calculation-input stream In(1≦u≦k) that is input into the u-th recording and calculating unit (the second recording and calculating unit 516, for example). The u-th record-calculation-input stream In includes the (2×a−1) frame NF (an odd-numbered frame) and the (2×a) frame SF (an even-numbered frame) that follows the (2×a−1) frame.

The second row in the diagram of FIG. 25 indicates processing performed by the u-th recording and calculating unit to the (k+1)th recording and calculating unit on the (2×a−1) frame NF and the (2×a) frame SF.

In this processing, the u-th recording and calculating unit and the like codes the (2×a−1) frame NF (for example, the frame 1 of FIG. 5) into the coded (2×a−1) frame CF1. It is to be noted that, in FIG. 25, the frame that is coded is indicated by hatching. Further, the u-th recording and calculating unit and the like perform adding processing AP (FIG. 25) to add the (2×a)th frame SF (frame 2) and the (2×a−1)th frame NF (frame 1) to generated an added frame Adf(frame 1+2) obtained through adding processing AP. The added frame Adf(frame 1+2) that is generated is coded into the coded added frame CF2a by the (u+1)th recording and calculating unit, and the like. Here, in some cases, the coding is performed on a frame (frame 1+2+3+4) obtained by adding a predetermined frame (the frame 1+2) to the added frame (3+4, for example). Here, the processing amount of the adding is smaller than the processing amount of the coding.

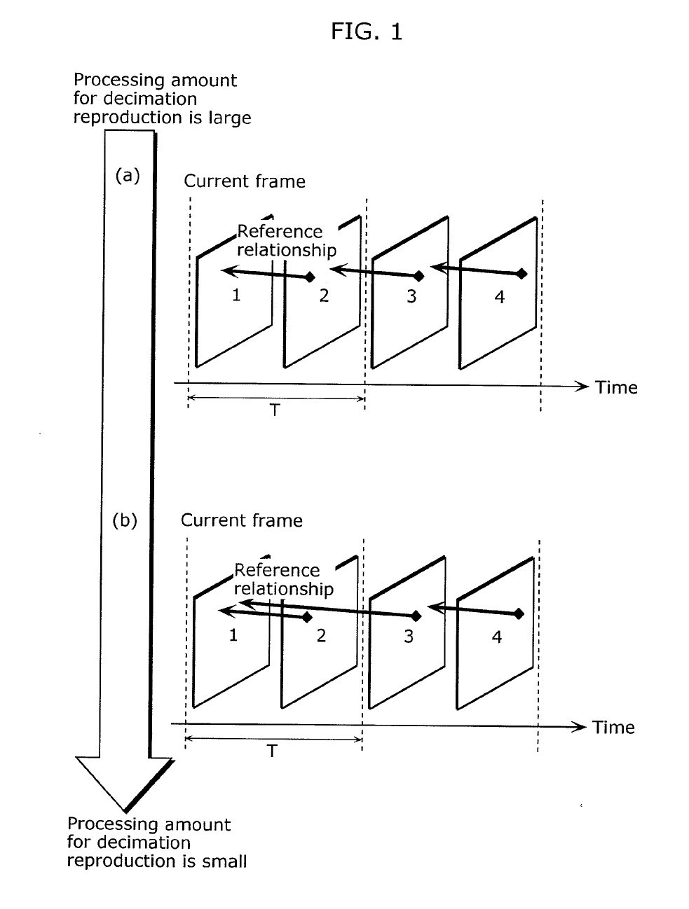

In the prior art 1 (refer to the first row of the diagram in FIG. 25 and FIG. 1(b)) and the prior art 2 (the second row of the diagram in FIG. 25 and FIG. 4), the adding processing AP described above is not performed, and each of the (2×a−1)th frame NF and the (2×a)th frame SF are merely coded. In addition, the processing amount of adding processing performed is small, as described above. Therefore, the processing amount of coding by the video camera system 1 is different from the processing amount of the prior arts (the prior art 1 and the prior art 2) by only this small processing amount, and thus the processing amount of coding by the video camera system 1 and the processing amount of the prior art are maintained substantially at the same amount (refer to FIG. 11).

The third row of the diagram in FIG. 25 shows the processing of the video camera system 1 in the case where, for example, both of the (2×a−1)th frame NF and the (2×a)th frame SF of the input stream In are used, such as the case where each of the (2×a−1)th frame NF and the (2×a)th frame SF of the input stream In is reproduced.

The video camera system 1 decodes a coded (2×a−1)th frame CF1 that is obtained by the coding (the frame 1 in FIG. 6, for example). Further, a coded added frame CF2a (or, a frame obtained by coding a processed frame described above, the frame 1+2) is decode, and subtraction is performed on the decoded added frame CF2a (or, the processed frame described above). The both of the (2×a−1)th frame NF1 and the (2×a)th frame NF2a which have been generated as described above are used.

Here, the prior arts (the prior art 1 and the prior art 2) are different from the above processing in that the subtraction is not performed. Here, the processing amount of subtraction is relatively small. Thus, in the video camera system 1 described above, the processing amount when using both of the frames is substantially the same as the processing amount of the prior arts.

The fourth row in the diagram of FIG. 25 shows a processing in the case where decimation is used, in which the display content including the (2×a−1)th frame NF and the (2×a)th frame SF is displayed by reproducing only one frame.

In the video camera system 1, a coded frame that is obtained by coding the added frame (the frame 1+2, for example) is decoded. With this, the number of frames decoded is reduced to one, while the frame used is the added frame, and thus the image quality is high.

On the other hand, in the prior art 1 (refer to FIG. 1(b)), the added frame is not used, and the image quality is low due to a lack of motion blur, and the like.

Further, in the prior art 2 (refer to FIG. 4), when decimation is used, two or more frames are decoded for generating the added frame. All of the frames included in the stream are decoded, for example.

Thus, according to the digital television system 1a, unlike the prior art 1 and the prior art 2, a high image quality is obtained while reducing the processing amount, making it possible to obtain a high image quality with small processing amount.

As described above, each of the following devices and the like are configured according to the above embodiment.

(A1) A recording device (the video encoder 900, the recording unit 151) is configured, which includes: a coding unit (the second coding unit 510 (and the first coding unit 504, the third coding unit 514)) that codes one frame (the frame 1+2) out of two consecutive frames (the frame 1+2, the frame 3+4: two processing frames) included in a stream (the k-th record-calculation-input stream in the second group in FIG. 5, for example: a processing stream); and an adding unit (the second adding unit 512 (and the first adding unit 506, the third adding unit 512) that adds the other frame of the two frames and the one frame.

(A2) In the recording device, the coding unit codes one processing frame (the frame 1+2) out of the (2×a−1)th processing frame (the frame 1+2) and the (2×a)th processing frame (the frame 3+4) which are included in one processing stream (the k-th record-calculation-input stream: the second group in FIG. 5) (a is an integer) so as to generate a coded frame as the a-th output frame included in one output stream (the k-th record-calculation-output stream), and the adding unit generates, as the a-th frame included in the other processing stream (the (k+1)th record-calculation-input stream), the a-th added frame (the frame 1+2+3+4) in which the (2×a−1)th processing frame (the frame 1+2) and the (2×a)th processing frame (the frame 3+4) which are included in the one processing stream (the k-th record-calculation-input stream) are added.

(A3) In the recording device, the one processing stream and the one output stream are the k-th processing stream (the k-th record-calculation-input stream) and the k-th output stream (the k-th record-calculation-output stream), respectively, the other processing stream is the (k+1)th processing stream (the (k+1)th record-calculation-input stream) (k≧1). The coding unit includes: the (k+1)th coding unit (the third coding unit 514) that codes each of the (2×a−1)th frame (the frame 1+2+3+4, for example) and the (2×a)th frame (the frame 5+6+7+8) which are included in the (k+1)th processing stream, so as to generate coded frames as the (2×a−1)th output frame and the (2×a)th frame which are included in the (k+1)th output stream (the (k+1)th record-calculation-output stream); and the u-th coding unit (the second coding unit 510, the first coding unit 504) that codes one processing frame out of the (2×a−1)th frame (the frame 1+2) and the (2×a)th frame (the frame 3+4) which are included in the u-th processing stream (the u-th record-calculation-input stream) to generate a coded frame as one output frame (the (2×a−1)th output frame) in the (2×a−1)th output frame and the (2×a)th output frame which are included in the u-th output stream (the u-th record-calculation-output stream) (1≦u≦k). The adding unit includes the u-th adding unit (the second adding unit 512, the first adding unit 506) that adds the (2×a−1)th frame (the frame 1+2) and the (2×a)th frame (the frame 3+4) which are included in the u-th processing stream (the u-th record-calculation-input stream), so as to generate an added frame as the a-th frame included in the (u+1)th processing stream ((u+1)th record-calculation-input stream).

(A4) The recording device includes a determination unit (the second selecting unit 507, the first selecting unit 501) that determines whether or not the processing frame included in the u-th processing stream is the one frame, causes the coding unit to code the processing frame determined as being the one frame, and causes the adding unit to generate the added frame of the processing frame determined as not being the one frame. The determination unit includes the first determination unit to the k-th determination unit (the first selecting unit 501 to the second selecting unit 507). The u-th determination unit performs the determination for the u-th processing stream.

(A5) In the recording device, the coding unit codes the processing frames each of which is the odd-numbered frame of a corresponding one of the first to the 2̂(k+1−u)th (=2̂(3−u)) processing frames (ÂB indicates B-th power of A) included in the u-th processing stream, and generates the u-th output stream (the u-th record-calculation-output stream) including 2̂(k−u)(2̂(2−u)) processing frames that have been coded, and the adding unit generates the (u+1)th processing stream (the (u+1)th record-calculation-output stream) including the 2̂(k−u) added frames that have been generated from the first to the 2̂(k+1−u)th processing frames of the u-th processing stream, and the number of added frames included in the (k+1)th processing stream (u=k) that has been generated (the(k+1)th (=3) record-calculation-output stream) is one (=k−u) (only the frame 1+2+3+4).

(A6) The recording device includes: an input unit (the input unit 500) which inputs N processing frames (N=2̂k=2̂(k+1−1)) included in the first processing stream; and the first recording processing unit to the (k+1)th recording processing unit (the first recording-calculation processing unit to the (k+1)th recording-calculation processing unit). In the recording device, the coding unit includes the t-th coding unit provided in the t-th recording processing unit (1≦t≦k+1), and the adding unit includes the t-th adding unit provided in the t-th recording processing unit (1≦u≦k). The first recording processing unit includes a storing unit that stores the odd-numbered frame and the even-numbered frame which are obtained from the input unit, the first coding unit included in the first recording processing unit codes the odd-numbered frame which has been stored, the storing unit stores a bitstream obtained from the first coding unit, as the first output stream, and the first adding unit included in the first recording processing unit adds the odd-numbered to frame and the even-numbered frame which have been stored. The q-th recording processing unit (2≦q k+1) includes a storing unit which stores the odd-numbered frame and the even-numbered frame which are obtained from the (q−1)th adding unit, the q-th coding unit codes the stored odd-numbered frame which has been obtained from the (q−1)th adding unit. The q-th recording processing unit includes a storing unit which stores the bitstream obtained form the q-th coding unit, as the q-th output stream, and the q-th adding unit included in the q-th recording processing unit adds the stored odd-numbered frame and the even-numbered frame. The recording device includes k+1 stages formed of the first recording processing unit to the (k+1)th recording processing unit.

(A7) A reproducing device (the reproducing unit 171, the video decoder 901) is configured, which includes: a decoding unit (the second decoding unit 604 (and the third decoding unit 601, the first decoding unit 609)) that decodes a coded frame obtained by coding one frame (the frame 1+2, for example), into the one frame, and subtracting unit (the second subtracting unit 606) that subtracts the one frame (the frame 1+2) from an added frame (the frame 1+2+3+4) in which the one frame and the other frame (the frame 3+4) that follows the one frame are added, so as to generate a subtracted frame as the other frame (the frame 3+4).

(A8) In the reproducing device, the decoding unit decodes the a-th preprocess frame (the frame 1+2, for example) included in one preprocess frame (the k-th reproduce-calculate-input stream, for example) (a is an integer) so as to generate a decoded frame as one of the (2×a−1)th processed frame or the (2×a)th processed frame which are included in one processed frame (the k-th reproduce-calculate-output stream), and the subtracting unit subtracts, from the a-th processed frame (the frame 1+2+3+4) included in the other processed stream (the (k+1)th reproduce-calculate-input stream) that includes, as the a-th processed frame, an added frame (the frame 1+2+3+4) in which the (2×a−1)th processed frame (the frame 1+2) and the (2×a)th processed frame (the frame 3+4) of the one processed stream are added, to generate a subtracted frame as the other frame (the frame 3+4) of the (2×a−1)th processed frame and the (2×a)th processed frame of the one processed stream (the k-th reproduce-calculate-output stream).

(A9) In the reproducing device, the one preprocess stream and the one processed stream are the k-th preprocess stream (the k-th reproduce-calculate-input stream) and the k-th processed stream (the k-th reproduce-calculate-output stream), and the other processed stream is the (k+1)th processed stream (the (k+1)th reproduce-calculate-output stream) (k≧1), the decoding unit includes: the (k+1)th decoding unit (the third decoding unit 601) that decodes the a-th preprocess frame included in the (k+1)th preprocess stream (the (k+1)th reproduce-calculate-input stream) to generate a decoded frame (the frame 1+2+3+4) as the a-th processed frame of the (k+1)th processed stream (the (k+1)th reproduce-calculate-output stream); and the v-th decoding unit (the second decoding unit 604) that decodes one of the (2×a−1)th preprocess frame and the (2×a)th preprocess frame which are included in the v-th preprocess stream (m≦v≦k) (the v-th reproduce-calculate-input stream) to generate a decoded frame (the frame 1+2, for example) as one of the (2×a−1)th processed frame (the frame 1+2) and the (2×a)th processed frame (the frame 3+4) which are included in the v-th processed stream (the v-th reproduce-calculate-output stream), the subtracting unit includes the v-th subtracting unit (the second subtracting unit 606) that subtracts, from the a-th processed frame included in the (v+1)th processed stream (the (k+1)th reproduce-calculate-output stream), the processed frame (the frame 1+2) of one of the (2×a−1)th processed frame and the (2×a)th processed frame which are included in the v-th processed stream (the v-th reproduce-calculate-output stream) to generate a subtracted frame as the other processed frame (the frame 3+4) of the v-th processed stream.

(A10) The reproducing device includes a selecting unit (the selecting unit 619) that, in the case where the reproducing device reproduces 2̂(L−1) frames during a period of the frame of one (k+1)th processed streams, where m=1, (1≦L≦k+1), generates only the (k+1)th processed stream to the (K+1−(L−1))th processed stream by using only the (k+1)th decoding unit to the (K+1−(L−1))th decoding unit and the (k+1)th subtracting unit to the (K+1−(L−1))th subtracting unit and causes the reproducing device to reproduce each of the processed streams included in the (K+1−(L−1))th processed stream.

(A11) The reproducing device includes a determination unit (the second selecting unit 617, the first selecting unit (the selecting unit 610, the selecting unit 618)) which: determines whether or not the processed frame included in the v-th processed stream is the one frame; selects, as a determined processed frame, a frame that is decoded by the decoding unit from the coded processed frame obtained by coding the processed frame in the case where the processed frame included in the v-th processed stream is the one frame; selects, as a determined processed frame, a frame that is generated by the subtracting unit from an added frame obtained by adding, as the other frame, the determined processed frame in the case where the processed frame included in the v-th processed stream is not the one frame. The determination unit includes the m-th determination unit to the k-th determination unit. The v-th determination unit performs the determining and selecting for the v-th processed stream.

(A12) In the reproducing device, a first preprocess stream to a (k+1)th preprocess stream which are a first output stream and a second to a (k+1)th output stream are processed, the first output stream being obtained by coding an odd-numbered frame in N processing frames included in the first processing stream where N=2̂k, and the second to the (k+1)th output stream being obtained by repeating k times, where 1≦u≦k: generating an added frame in which the odd-numbered frame and an even-numbered frame which are included in the u-th processing stream are added, where 1≦u≦k; and recording a (u+1)th output stream in which only the odd-numbered frame in an intermediate stream including each of added frames which have been generated. The reproducing device includes: a reproducing unit; and a first reproducing processing unit to a (k+1)th reproducing processing unit. In the reproducing device, the decoding unit includes a t-th decoding unit provided in a t-th reproducing processing unit, where 1≦t≦(k+1), the subtracting unit includes a u-th subtracting unit provided in a u-th reproducing processing unit, where 1≦u≦k, in a (k+1)th recording processing unit, the (k+1)th decoding unit provided in the (k+1)th recording processing unit is configured to decode and reconstruct the (k+1)th preprocess stream, the reproducing unit is configured to reproduce a frame obtained from the (k+1)th decoding unit in the case where L=1, in the u-th recording processing unit, where 1≦u≦k, the u-th decoding unit included in the u-th recording processing unit is configured to decode and reconstruct the u-th preprocess stream, and the u-th subtracting unit included in the u-th recording processing unit is configured to subtract, from 2̂((k+1)−u)/2(=2̂(k−u)) frames reconstructed from the (k+1)th to the (u+1)th preprocess streams, corresponding odd-numbered frames reconstructed from the (u+1)th preprocess streams by the u-th decoding unit, the reproducing unit is, in the case where L≧2, configured to reproduce, as an odd-numbered frame, a frame obtained from the (K+1−(L−1))th decoding unit, and to reproduce, as an even-numbered frame, a frame obtained from the (K+1−(L−1))th subtracting unit, and the first reproducing processing unit to the (k+1)th reproducing processing unit form (k+1)th stages.

(A13) A video camera system is configured, which includes a CCD peripheral and a microphone as input interfaces of an image and an audio; a camera signal processing unit configured to control an automatic focus section; a signal processing unit configured to code and decode a moving picture, and to code and decode an audio; an interface which outputs the image and the audio; an interface which stores recording data; the recording device according to A3; and the reproducing device according to A9.

(A14) A digital television system is configured, which includes: a unit configured to perform digital modulation and demodulate a unit configured to perform descrambling and decoding on a transport stream; a signal processing unit configured to decode a moving picture and an audio; a unit configured to output the image and the audio; and said reproducing device according to A9.

Further, the following devices and the like are configured (see FIG. 10).

(B1) A recording method is configured by which Log 2N+1 bitstream is generated by repeating Log 2N times (base 2 logarithm) the following processes for N frames (N is a power of two): recording a bitstream in which an odd-numbered frame is coded; generating a frame in which the odd-numbered frame and an even-numbered frame are added together, and recording a bitstream in which coding is performed on only the odd-numbered frame of the added frame.

(B2) A reproducing method is configured by which the following processes are carried out, for N frames (N is a power of two), on a first bitstream in which an odd-numbered frame is coded and a bitstream from the second to the (Log 2N+1)th bitstream, which is obtained by repeating Log 2N times (base 2 logarithm), generating a frame in which an odd-numbered frame and an even-numbered frame of a current frame are added together and recording a bitstream in which coding is performed on only the odd-numbered frame of the added frame: reproducing a frame which is obtained by reproducing and reconstructing the (Log 2N+1)th bitstream when reproducing one frame in the N frames; reproducing, as an odd-numbered frame, a frame obtained by decoding and reconstructing the Log 2N-th bitstream and reconstructing and reproducing, as an even-numbered frame, a frame obtained by subtracting the odd-numbered frame from the frame obtained by reconstructing from the (Log 2N+1)th bitstream when reproducing two frames in the N frames; and reproducing, as an odd-numbered frame, a frame obtained by decoding and reconstructing the (Log 2M+1)th bitstream (M is a power of 2 and is three or more and less than N), and reproducing, as an even-numbered frame, a frame obtained by subtracting, from M/2 frame obtained by reconstructing from the Log 2M-th bitstream to the (Log 2N+1)th bitstream, the odd-numbered frame obtained by reconstructing from a corresponding (Log 2M+1)th bitstream when reproducing M frames in the N frames.

(B3) A recording device is configured which includes: a first recording unit that includes: an input unit that inputs N frame (N is a power of two); a storing unit that stores an odd-numbered frame and an even-numbered frame which are obtained from the input unit; and a coding unit that codes the odd-numbered frame; a storing unit that stores a bitstream obtained from the coding unit; and a second recording unit that includes: an adding unit that adds the odd-numbered frame and the even-numbered frame; a storing unit that stores the odd-numbered frame and the even-numbered frame which have been obtained from the adding unit; a coding unit that codes the odd-numbered frame obtained from the adding unit; and a storing unit that stores a bitstream obtained from the coding unit. Each of the first recording unit and the second recording unit includes Log 2N stages (base 2 logarithm).

(B4) A reproducing device is configured which includes, for N frames (N is a power of two), on a first bitstream in which an odd-numbered frame is coded and a bitstream from the second to the (Log 2N+1)th bitstream, which is obtained by repeating Log 2N times (base 2 logarithm), generating a frame in which an odd-numbered frame and an even-numbered frame of a current frame are added together and recording a bitstream in which coding is performed on only the odd-numbered frame of the added frame: a first reproducing unit that includes: a decoding unit that decodes and reconstructs the (Log 2N+1)th bitstream; and a reproducing unit that reproduces the frame obtained from the decoding unit in the case where one frame of N frames is reproduced; and a second reproducing unit that includes: a decoding unit that decodes and reconstructs the (Log 2M+1)th bitstream; a reproducing unit that reproduces the frame obtained from the decoding unit; a subtracting unit that subtracts, from M/2 frame reconstructed from the (Log 2M+1)th to the (Log 2N+1)th bitstream, the odd-numbered frame reconstructed from the corresponding (Log 2M+1)th bitstream; and a reproducing unit that reproduces the frame obtained from the subtracting unit, as the even-numbered frame. Each of the first reproducing unit and the second reproducing unit includes Log 2N stages (base 2 logarithm).

(B5) A video camera system is configured which includes: a CCD peripheral and a microphone as input interfaces of an image and an audio; a camera signal processing unit configured to control an automatic focus section; a signal processing unit configured to code and decode a moving picture, and to code and decode an audio; an interface which outputs the image and the audio; an interface which stores recording data. The video camera system includes a means, with which Log 2N+1 bitstream is generated by repeating Log 2N times (base 2 logarithm) the following processes for N frames (N is a power of two): recording a bitstream in which an odd-numbered frame is coded; generating a frame in which the odd-numbered frame and an even-numbered frame are added together, and recording a bitstream in which coding is performed on only the odd-numbered frame of the added frame, in the moving picture coding. The video camera system includes a unit, with which the following processes are carried out, for N frames (N is a power of two), in the moving picture decoding, on a first bitstream in which an odd-numbered frame is coded and a bitstream from the second to the (Log 2N+1)th bitstream which is obtained by repeating Log 2N times (base 2 logarithm), generating a frame in which an odd-numbered frame and an even-numbered frame of a current frame are added together and recording a bitstream in which coding is performed on only the odd-numbered frame of the added frame: reproducing a frame which is obtained by decoding and reconstructing the (Log 2N+1)th bitstream when reproducing one frame in the N frames; reproducing, as an odd-numbered frame, a frame obtained by decoding and reconstructing the Log 2N-th bitstream and reconstructing and reproducing, as an even-numbered frame, a frame obtained by subtracting the odd-numbered frame from the frame obtained by reconstructing from the (Log 2N+1)-th bitstream when reproducing two frames in the N frames; and reproducing, as an odd-numbered frame, a frame obtained by reproducing and reconstructing the (Log 2M+1)th bitstream (M is a power of 2 and is three or more and less than N), and reproducing, as an even-numbered frame, a frame obtained by subtracting, from M/2 frame obtained by reconstructing from the Log 2M-th bitstream to the (Log 2N+1)th bitstream, the odd-numbered frame obtained by reconstructing from a corresponding (Log 2M+1)th bitstream when reproducing M frames in the N frames.

(B6) A digital television system is configured which includes: a unit configured to perform digital modulation and demodulate a unit configured to perform descrambling and decoding on a transport stream; a signal processing unit configured to decode a moving picture and an audio; a unit configured to output the image and the audio; and the reproducing device according to claim 9. The digital television system includes a unit, with which the following processes are carried out, for N frames (N is a power of two), in the moving picture decoding, on a first bitstream in which an odd-numbered frame is coded and a bitstream from the second to the (Log 2N+1)th bitstream which is obtained by repeating Log 2N times (base 2 logarithm), generating a frame in which an odd-numbered frame and an even-numbered frame of a current frame are added together and recording a bitstream in which coding is performed on only the odd-numbered frame of the added frame: reproducing a frame which is obtained by decoding and reconstructing the (Log 2N+1)th bitstream when reproducing one frame in the N frames; reproducing, as an odd-numbered frame, a frame obtained by decoding and reconstructing the Log 2N-th bitstream and reconstructing and reproducing, as an even-numbered frame, a frame obtained by subtracting the odd-numbered frame from the frame obtained by reconstructing from the (Log 2N+1)-th bitstream when reproducing two frames in the N frames; and reproducing, as an odd-numbered frame, a frame obtained by reproducing and reconstructing the (Log 2M+1)th bitstream (M is a power of 2 and is three or more and less than N), and reproducing, as an even-numbered frame, a frame obtained by subtracting, from M/2 frame obtained by reconstructing from the Log 2M-th bitstream to the (Log 2N+1)th bitstream, the odd-numbered frame obtained by reconstructing from a corresponding (Log 2M+1)th bitstream when reproducing M frames in the N frames.

It is to be noted that, one frame in consecutive frames is coded, as described above. Here, the one frame that is coded may be a frame positioned behind the other frame (the (2×a)th frame), instead of a frame positioned in front of the other frame (the (2×a−1)th frame), in these two frames.

When the one frame that is coded is the frame positioned behind the other frame, as described above, it is possible to start coding processing, in advance, on the one frame prior to the time when processing on the frame positioned behind can be started. Thus, it is possible to end the processing of coding the one frame and other processing following the coding processing early, thereby reducing delay in processing. Further, it is possible to distribute processing load by avoiding performing much processing after the time when processing on the frame positioned behind can be started.

Furthermore, the processing of coding the one frame may be started after the start of the processing of adding the one frame (the frame 1, for example) and the other frame (the frame 2) to generate an added frame (ht frame 1+2).

On the other hand, when the processing of coding the one frame is started prior to the start of the adding processing, it is possible to reduce or eliminate delay in processing, as described above. Further, it is possible to distribute processing load

### INDUSTRIAL APPLICABILITY

The recording and reproducing method and the device of the same according to the present invention are capable of presenting excellent image quality using movie cameras performing high speed imaging, digital televisions reproducing a moving picture, and even reproducing devices with insufficient performance, and are useful for reducing power consumption and costs.

1. A recording device comprising:
a coding unit configured to code only one frame out of two consecutive frames included in a stream; and
an adding unit configured to add an other frame of the two frames and the one frame.

2. The recording device according to claim 1,
wherein said coding unit is configured to code one processing frame out of a (2×a−1)th processing frame and a (2×a)th processing frame which are included in one processing stream, where a is an integer, so as to generate a coded frame as an a-th output frame included in one output stream, and
said adding unit is configured to generate an a-th added frame obtained by adding the (2×a−1)th processing frame and the (2×a)th processing frame which are included in the one processing stream, as an a-th frame included in an other processing stream.

3. The recording device according to claim 2,
wherein the one processing stream and the one output stream are a k-th processing stream and a k-th output stream, respectively, and the other processing stream is a (k+1)th processing stream, where k≧1,
said coding unit includes:
a (k+1)th coding unit configured to code a (2×a−1)th frame and a (2×a)th frame which are included in the (k+1)th processing stream, so as to generate coded frames as a (2×a−1)th output frame and a (2×a)th frame, respectively, which are included in a (k+1)th output stream; and
a u-th coding unit configured to code one processing frame out of a (2×a−1)th frame and a (2×a)th frame which are included in a u-th processing stream, so as to generate a coded frame as one output frame out of a (2×a−1)th output frame and a (2×a)th output frame which are included in a u-th output stream, where 1≦u≦k, and
said adding unit includes a u-th adding unit configured to add the (2×a−1)th frame and the (2×a)th frame which are included in the u-th processing stream, so as to generate an added frame as an a-th frame included in a (u+1)th processing stream.

4. The recording device according to claim 3,
comprising a determination unit configured to: determine whether or not a processing frame included in the u-th processing stream is the one frame; cause said coding unit to code the processing frame determined as being the one frame; and cause said adding unit to generate the added frame of a processing frame determined as not being the one frame, said determination unit including a first determination unit to a k-th determination unit,
wherein said u-th determination unit is configured to perform the determining for the u-th processing stream.

5. The recording device according to claim 2,
wherein said coding unit is configured to code processing frames each of which is an odd-numbered frame of a corresponding one of a first to a 2̂(k+1−u)th processing frames included in the u-th processing stream, where ÂB indicates B-th power of A, and to generate the u-th output stream including 2̂(k−u) processing frames that have been coded,
said adding unit is configured to generate a (u+1)th processing stream including 2̂(k−u) added frames that have been generated from the first to the 2̂(k+1−u)th processing frames of the u-th processing stream, and
the (k+1)th processing stream that has been generated includes one added frame (=k−u), where u=k.

6. The recording device according to claim 2,
comprising: an input unit configured to input N processing frames included in the first processing stream, where N=2̂k=2̂(k+1−1); and
a first recording processing unit to a (k+1)th recording processing unit,
wherein said coding unit includes a t-th coding unit provided in said t-th recording processing unit, where 1≦t≦k+1,
said adding unit includes a t-th adding unit provided in said t-th recording processing unit, where 1≦u≦k,
said first recording processing unit includes a storing unit configured to store an odd-numbered frame and an even-numbered frame which are obtained from said input unit,
said first coding unit included in said first recording processing unit is configured to code the odd-numbered frame that has been stored,
said first recording processing unit includes a storing unit configured to store a bitstream obtained from said first coding unit, as the first output stream,
said first adding unit included in said first recording processing unit is configured to add the odd-numbered frame and the even-numbered frame which have been stored,
said q-th recording processing unit includes a storing unit configured to store an odd-numbered frame and an even-numbered frame which are obtained from said (q−1)th adding unit, where 2≦q≦k+1,
a q-th coding unit is configured to code the stored odd-numbered frame obtained from said (q−1)th adding unit,
said q-th recording processing unit includes a storing unit configured to store a bitstream obtained from said q-th coding unit, as the q-th output stream,
said q-th adding unit included in said q-th recording processing unit is configured to add the odd-numbered frame and the even-numbered frame which have been stored, and
said first recording processing unit to said (k+1)th recording processing unit form (k+1)th stages.

7. A reproducing device comprising:
a decoding unit configured to decode a coded frame obtained by coding one frame, into the one frame, and
a subtracting unit configured to subtract the one frame from an added frame in which the one frame and the other frame that follows the one frame are added so as to generate a subtracted frame as the other frame.

8. The reproducing device according to claim 7,
wherein said decoding unit is configured to decode an a-th preprocess frame included in one preprocess frame, where a is an integer, so as to generate a decoded frame as one of the (2×a−1)th processed frame or the (2×a)th processed frame which are included in one processed frame, and
said subtracting unit is configured to subtract, from the a-th processed frame included in the other processed stream that includes, as the a-th processed frame, an added frame in which the (2×a−1)th processed frame and the (2×a)th processed frame of the one processed stream are added, to generate a subtracted frame as the other frame of the (2×a−1)th processed frame and the (2×a)th processed frame of the one processed stream.

9. The reproducing device according to claim 8,
wherein the one preprocess stream and the one processed stream are a k-th preprocess stream and a k-th processed stream, and the other processed stream is a (k+1)th processed stream, where k≧1,
said decoding unit includes: a (k+1)th decoding unit configured to decode the a-th preprocess frame included in the (k+1)th preprocess stream to generate a decoded frame as the a-th processed frame of the (k+1)th processed stream; and a v-th decoding unit configured to decode one of the (2×a−1)th preprocess frame and the (2×a)th preprocess frame which are included in the v-th preprocess stream to generate a decoded frame as one of the (2×a−1)th processed frame and the (2×a)th processed frame which are included in the v-th processed stream, where m≦v≦k, and said subtracting unit includes the v-th subtracting unit configured to subtract, from the a-th processed frame included in the (v+1)th processed stream, the processed frame of one of the (2×a−1)th processed frame and the (2×a)th processed frame which are included in the v-th processed stream to generate a subtracted frame as an other processed frame of the v-th processed stream.

10. The reproducing device according to claim 9,
wherein m=1,
said reproducing device, in the case where the reproducing device reproduces 2̂(L−1) frames during a period of a frame of one (k+1)th processed stream, where 1≦L≦k+1, comprising a selecting unit configured to cause only said (k+1)th decoding unit to said (K+1−(L−1))th decoding unit and said (k+1)th subtracting unit to said (K+1−(L−1))th subtracting unit to generate only a (k+1)th processed stream to a (K+1−(L−1))th processed stream, and to cause said reproducing device to reproduce each of the processed streams included in the (K+1−(L−1))th processed stream.

11. The reproducing device according to claim 9,
comprising a determination unit configured to: determine whether or not the processed frame included in the v-th processed stream is the one frame; select as a determined processed frame, when determined as being the one frame, a frame that is decoded by said decoding unit from the coded processed frame obtained by coding the processed frame; and select as a determined processed frame, when determined as not being the one frame, a frame that is generated by said subtracting unit from an added frame obtained by adding the determined processed frame as the other frame, said determination unit including a m-th determination unit to a k-th determination unit, and
a v-th determination unit performing the determination and the selection for the v-th processed stream.

12. The reproducing device according to claim 10,
wherein a first preprocess stream to a (k+1)th preprocess stream which are a first output stream and a second to a (k+1)th output stream are processed, the first output stream being obtained by coding an odd-numbered frame in N processing frames included in the first processing stream where N=2̂k, and the second to the (k+1)th output stream being obtained by repeating k times, where 1≦u≦k: generating an added frame in which the odd-numbered frame and an even-numbered frame which are included in the u-th processing stream are added, where 1≦u≦k; and recording a (u+1)th output stream in which only the odd-numbered frame in an intermediate stream including each of added frames which have been generated,
said reproducing device comprising: a reproducing unit; and a first reproducing processing unit to a (k+1)th reproducing processing unit,
wherein said decoding unit includes a t-th decoding unit provided in a t-th reproducing processing unit, where 1≦t≦(k+1),
said subtracting unit includes a u-th subtracting unit provided in a u-th reproducing processing unit, where 1≦u≦k,
in a (k+1)th recording processing unit, said (k+1)th decoding unit provided in said (k+1)th recording processing unit is configured to decode and reconstruct the (k+1)th preprocess stream,
said reproducing unit is configured to reproduce a frame obtained from said (k+1)th decoding unit in the case where L=1,
in said u-th recording processing unit, where 1≦u≦k,
said u-th decoding unit included in said u-th recording processing unit is configured to decode and reconstruct the u-th preprocess stream, and said u-th subtracting unit included in said u-th recording processing unit is configured to subtract, from 2̂((k+1)−u)/2(=2̂(k−u)) frames reconstructed from the (k+1)th to the (u+1)th preprocess streams, corresponding odd-numbered frames reconstructed from the (u+1)th preprocess streams by said u-th decoding unit,
said reproducing unit is, in the case where L≧2, configured to reproduce, as an odd-numbered frame, a frame obtained from said (K+1−(L−1))th decoding unit, and to reproduce, as an even-numbered frame, a frame obtained from said (K+1−(L−1))th subtracting unit, and
said first reproducing processing unit to said (k+1)th reproducing processing unit form (k+1)th stages.

13. A recording method comprising:
coding only one frame out of two consecutive frames included in a stream; and
adding an other frame of the two frames and the one frame.

14. A reproducing method comprising:
decoding a coded frame obtained by coding one frame, into the one frame, and
subtracting the one frame from an added frame in which the one frame and the other frame that follows the one frame are added, so as to generate a subtracted frame as the other frame.

15. An integrated circuit comprising:
a coding unit configured to code only one frame out of two consecutive frames included in a stream; and
an adding unit configured to add an other frame of the two frames and the one frame.

16. An integrated circuit comprising:
a decoding unit configured to decode a coded frame obtained by coding one frame, into the one frame, and
a subtracting unit configured to subtract the one frame from an added frame in which the one frame and the other frame that follows the one frame are added, so as to generate a subtracted frame as the other frame.

17. A computer program which causes a computer to function as:
a coding unit configured to code only one frame out of two consecutive frames included in a stream; and
an adding unit configured to add an other frame of the two frames and the one frame.

18. A computer program which causes a computer to function as:
a decoding unit configured to decode a coded frame obtained by coding one frame, into the one frame, and
a subtracting unit configured to subtract the one frame from an added frame in which the one frame and the other frame that follows the one frame are added, so as to generate a subtracted frame as the other frame.

19. A video camera system comprising:
a CCD peripheral and a microphone as input interfaces of an image and an audio;
a camera signal processing unit configured to control an automatic focus section;
a signal processing unit configured to code and decode a moving picture, and to code and decode an audio;
an interface which outputs the image and the audio;
an interface which stores recording data;
a recording device including: a coding unit configured to code only one frame out of two consecutive frames included in a stream; and an adding unit configured to add the one frame and the other of the two frames; and;
a reproducing device including: a decoding unit configured to decode a coded frame obtained by coding one frame, into the one frame; and a subtracting unit configured to subtract the one frame from an added frame in which the one frame and the other frame that follows the one frame are added, to generate a subtracted frame as the other frame.

20. A digital television system comprising:
a unit configured to perform digital modulation and demodulate a unit configured to perform descrambling and decoding on a transport stream;
a signal processing unit configured to decode a moving picture and an audio;
a unit configured to output the image and the audio; and
said reproducing device according to claim 9.

21. The recording device according to claim 1, further comprising
an added frame coding unit configured to code only an added frame obtained from the addition performed by said adding unit.

22. The reproducing device according to claim 7,
said device capable of switching between: reproducing only the added frame among the one frame, the other frame, and the added frame and displaying only the added frame; and
displaying alternately the one frame and the subtracted frame, the one frame being obtained by decoding, by said decoding unit, the coded frame obtained by coding the one frame, and the subtracted frame being generated by said subtracting unit from the added frame obtained by the decoding, by said decoding unit, the coded frame obtained by coding the added frame.
